(19) United States
(12) Patent Application Publication
(10) Pub. No.: US 2025/0119504 A1
(43) Pub. Date: Apr. 10, 2025

(54) NON-TRANSITORY COMPUTER-READABLE STORAGE MEDIUM STORING PROGRAM

(71) Applicant: CANON KABUSHIKI KAISHA, Tokyo (JP)

(72) Inventors: MASATAKA IURA, Chiba (JP); YOSHIRO MIHIRA, Tokyo (JP)

(21) Appl. No.: 18/910,075

(22) Filed: Oct. 9, 2024

(30) Foreign Application Priority Data
Oct. 10, 2023 (JP) 2023-175551

(51) Int. Cl. H04N 1/00

(52) U.S. Cl. CPC H04N 1/00925; H04N 1/0048

(57) ABSTRACT

After the connection between the predetermined access point and the first information processing apparatus is established by instructing the host OS to execute the first processing, communication via the connection between the predetermined access point and the first information processing apparatus is executed. After the connection between the predetermined access point and the second information processing apparatus is established by instructing the guest OS to execute the second processing, communication via the connection between the predetermined access point and the second information processing apparatus is executed.

### BACKGROUND OF THE INVENTION

### Field of the Invention

The present invention relates to a non-transitory computer-readable storage medium storing a program of an application operating on an OS.

### Description of the Related Art

Japanese Patent Laid-Open No. 2023-26168 describes a technique of displaying a warning screen for prompting a student to stop gazing a screen based on his/her screen gazing time and starting an operation lock for prohibiting an operation. In Japanese Patent Laid-Open No. 2023-26168, it is described that an operation other than an operation associated with a sleep state cannot be performed, and thus the student can rest his/her eyes.

### SUMMARY OF THE INVENTION

In a case where an application program shifts the process to another program, and stands by for processing of the other program, an application screen and a screen of the other program may be displayed as different windows depending on the configuration of an OS. In this case, if an unexpected user operation is accepted on the application screen, the application program cannot appropriately execute processing.

The present invention provides a non-transitory computer-readable storage medium storing a program for controlling processing of an application program in accordance with the configuration of an OS.

The present invention in one aspect provides a non-transitory computer-readable storage medium that stores a program operatable on an operating system (OS), which when executed by one or more processors of a first information processing apparatus having a first operating environment on a first OS operating as a host OS but not on a guest OS, causes the first information processing apparatus to perform a first method, the first method comprising: instructing, based on execution of a predetermined operation on a predetermined screen displayed by the program, the host OS to execute first processing for establishing connection between a predetermined access point and the first information processing apparatus, and executing, after the connection between the predetermined access point and the first information processing apparatus is established by instructing the host OS to execute the first processing, communication via the connection between the predetermined access point and the first information processing apparatus; wherein the program, which when executed by one or more processors of a second information processing apparatus having a second operating environment on a second OS operating as the host OS and on the guest OS, causes the second information processing apparatus to perform a second method, the second method comprising: instructing, based on execution of the predetermined operation on the predetermined screen displayed by the program, the guest OS to execute second processing for establishing connection between the predetermined access point and the second information processing apparatus, executing predetermined control not to execute processing based on an operation on the predetermined screen after instructing the guest OS to execute the second processing, and executing, after the connection between the predetermined access point and the second information processing apparatus is established by instructing the guest OS to execute the second processing, communication via the connection between the predetermined access point and the second information processing apparatus.

According to the present invention, it is possible to control processing of an application program in accordance with the configuration of an OS.

Further features of the present invention will become apparent from the following description of exemplary embodiments with reference to the attached drawings.

### BRIEF DESCRIPTION OF THE DRAWINGS

FIG. 1 is a block diagram showing a configuration including an information processing apparatus and a communication apparatus;

FIG. 2 is a sequence chart showing a wireless connection sequence in a WFD mode;

FIGS. 3A and 3B are block diagrams each showing the software configuration of the information processing apparatus;

FIGS. 4A to 4D are views each showing a user interface screen;

FIGS. 5A to 5D are views each showing a user interface screen;

FIGS. 6A to 6D are views each showing a user interface screen;

FIGS. 7A and 7B are views each showing a user interface screen;

FIGS. 8A to 8D are views each showing a user interface screen;

FIG. 9 is a sequence chart between an application and an OS;

FIG. 10 is a sequence chart between the application and an OS;

FIG. 11 is a flowchart illustrating network setup processing;

FIG. 12 is a flowchart illustrating processing of the application;

FIG. 13 is a flowchart illustrating the processing of the application;

FIG. 14 is a flowchart illustrating the processing of the application; and

FIG. 15 is a block diagram showing functional blocks of the application.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

An information processing apparatus and a communication apparatus included in a communication system according to this embodiment will be described. In this embodiment, a smartphone is exemplified as the information processing apparatus, but the present invention is not limited to this and various kinds of apparatuses such as a portable terminal, a notebook PC, a tablet terminal, a Personal Digital Assistant (PDA), and a digital camera are applicable. As the communication apparatus, various kinds of apparatuses are applicable as long as they can perform wireless communication with the information processing apparatus. For example, concerning a printer, an inkjet printer, a full-color laser beam printer, a monochrome printer, and the like are applicable. Furthermore, not only a printer but also a scanner, a copying machine, a facsimile apparatus, a portable terminal, a smartphone, a notebook PC, a tablet terminal, a PDA, a digital camera, a music playback device, a television, a smart speaker, and the like are applicable. In addition, a multi-function peripheral having a plurality of functions such as a copying function, a FAX function, a print function, and a scanner function is also applicable. In this embodiment, the communication apparatus is assumed to be a multi-function printer having a print function and a scanner function.

### <Hardware Configuration of Each Apparatus>

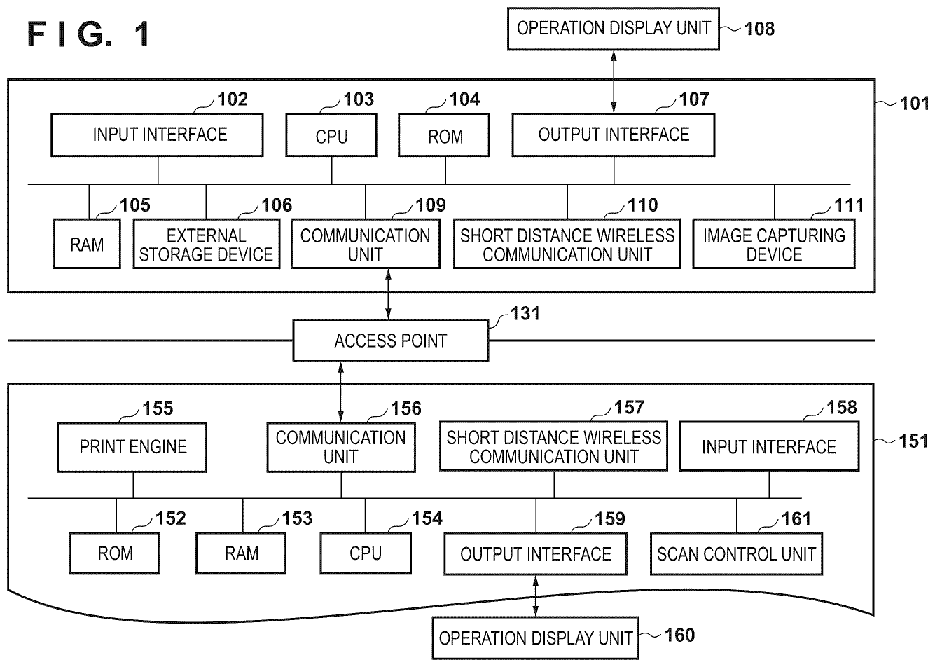

First, the configuration of an information processing apparatus included in the communication system according to this embodiment, and that of a communication apparatus that can communicate with the information processing apparatus will be explained with reference to the block diagram of FIG. 1. The following configuration will be exemplified in this embodiment, but functions are not specifically limited to those shown in FIG. 1.

An information processing apparatus 101 includes an input interface 102, a CPU 103, a ROM 104, a RAM 105, an external storage device 106, an output interface 107, an operation display unit 108, a communication unit 109, a short distance wireless communication unit 110, and an image capturing device 111. The input interface 102 is an interface configured to accept a data input and an operation instruction from the user, and is formed by a physical keyboard, display buttons, a touch panel, and the like. Note that the output interface 107 and the input interface 102 (to be described later) may have the same arrangement, and output of a screen and acceptance of an operation from the user may be done by the same arrangement.

The CPU 103 is a system control unit and controls the whole information processing apparatus 101. The ROM 104 stores permanent data such as control programs to be executed by the CPU 103, data tables, and an embedded operating system (to be referred to as an OS hereinafter) program. In this embodiment, the control programs stored in the ROM 104 perform software execution control such as scheduling, task switch, and interrupt processing under the management of the embedded OS stored in the ROM 104. Note that in this embodiment, the OS that is held in the ROM 104 and operates on the information processing apparatus 101 is assumed to be an Android® OS provided by Google Inc. or a Chrome® OS provided by Google Inc. When the OS operating on the information processing apparatus 101 is the Chrome OS, the ROM 104 holds even a virtual Android OS for operating an Android OS application (to be described later) on the information processing apparatus 101.

The RAM 105 is formed by a Static Random Access Memory (SRAM) or the like, which needs a backup power supply. Note that the RAM 105 can store important data such as program control variables without volatilization because the data are held by a primary battery (not shown) for data backup. In addition, a memory area for storing setting information of the information processing apparatus 101, management data of the information processing apparatus 101, and the like is also provided in the RAM 105. Furthermore, the RAM 105 is also used as the main memory and work memory of the CPU 103.

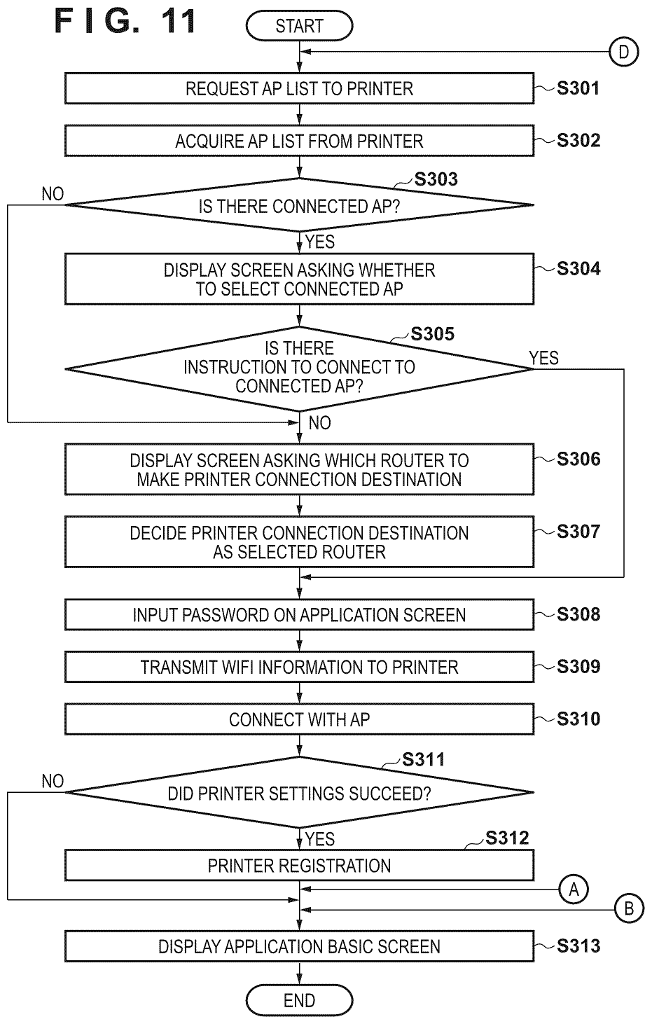

The external storage device 106 includes an application program (to be described as an application hereinafter) having a function of communicating with a communication apparatus 151. Note that more specifically, for example, the application is an application having a print function for causing the communication apparatus 151 to execute printing, and a scan function for causing the communication apparatus 151 to execute scanning. However, the application is not limited to this form, and may be an application (print application or scan application) having either of the print function and the scan function, or an application having another function. For example, the application may be a setup application having a function of executing network setup processing for connecting the communication apparatus 151 to an external access point. This embodiment assumes that the application is a setup application having all of the print function, the scan function, and the function of executing the network setup processing. The external access point is, for example, an access point 131 (to be described later). The network setup processing corresponds to processing shown in FIG. 11 to be described later. As an example, assume that the setup application of this embodiment is a setup application having functional blocks 1501 to 1504 for executing the above-described functions, as shown in FIG. 15. In particular, the setup application of this embodiment has a functional block 1505 for determining whether the information processing apparatus 101 operates in the first environment or the second environment. Furthermore, the setup application of this embodiment is not limited to the functions shown in FIG. 15, and has another functional block appropriately. The external storage device 106 also has various programs such as a print information generation program for generating print information interpretable by the communication apparatus 151, and an information transmission/reception control program for performing transmission/reception to/from the communication apparatus 151 connected via the communication unit 109. These programs may be programs included in the above-described setup application or programs configured separately from the setup application. The external storage device 106 saves various kinds of information to be used by these programs. The external storage device 106 also saves image data obtained from another information processing apparatus or the Internet via the communication unit 109. Note that the setup application in this embodiment is an application for the Android OS.

The output interface 107 is an interface that performs control for causing the operation display unit 108 to perform display of data and notification of the state of the information processing apparatus 101. The operation display unit 108 is formed by a Light-Emitting Diode (LED), a Liquid Crystal Display (LCD), or the like, and performs display of data and notification of the state of the information processing apparatus 101. Note that a software keyboard including keys such as numerical input keys, a mode setting key, an OK key, a cancel key, and a power key may be provided on the operation display unit 108 so that an input from the user is accepted via the operation display unit 108.

The communication unit 109 is configured to be connected to an apparatus such as the communication apparatus 151 to execute data communication. For example, the communication unit 109 can be connected to an access point (not shown) in the communication apparatus 151. When the communication unit 109 and the access point in the communication apparatus 151 are connected to each other, the information processing apparatus 101 and the communication apparatus 151 can communicate with each other. The access point will sometimes be referred to as an AP hereinafter. Note that the communication unit 109 may directly communicate with the communication apparatus 151 by wireless communication, or may communicate with the communication apparatus 151 via an access point 131 existing outside the information processing apparatus 101 and the communication apparatus 151. As the wireless communication method, the IEEE 802.11 communication standard is used in this embodiment. Note that the IEEE 802.11 communication standard is Wi-Fi®.

As the access point 131, for example, a device such as a wireless LAN router can be used. Note that in this embodiment, a method of connecting the information processing apparatus 101 and the communication apparatus 151 directly without intervention of the external access point will be referred to as a direct connection method hereinafter. In addition, a method of connecting the information processing apparatus 101 and the communication apparatus 151 via the external access point 131 will be referred to as an infrastructure connection method hereinafter.

The short distance wireless communication unit 110 is configured to be wirelessly connected to an apparatus such as the communication apparatus 151 at a short distance and execute data communication, and performs communication by a communication method different from that of the communication unit 109. The short distance wireless communication method used by the short distance wireless communication unit 110 is, for example, Bluetooth® or Near Field Communication (NFC). Bluetooth may be Bluetooth Classic or Bluetooth Low Energy. The short distance wireless communication unit 110 can be connected to a short distance wireless communication unit 157 in the communication apparatus 151.

The image capturing device 111 is a device that converts an image captured by an image sensor into digital data. The digital data is temporarily stored in the RAM 105. Then, the digital data is converted into a predetermined image format by a program executed by the CPU 103, and saved as image data in the external storage device 106.

The communication apparatus 151 includes a ROM 152, a RAM 153, a CPU 154, a print engine 155, a communication unit 156, the short distance wireless communication unit 157, an input interface 158, an output interface 159, an operation display unit 160, and a scan control unit 161. When a connection mode (communication mode) is set, the communication apparatus 151 can operate in the set connection mode.

The communication unit 156 is configured to allow the communication apparatus 151 to communicate with another apparatus. In this embodiment, the communication unit 156 performs communication in accordance with the IEEE 802.11 communication standard. The communication unit 156 includes, as an access point in the communication apparatus 151, an access point for performing connection to an apparatus such as the information processing apparatus 101. Note that the access point can be connected to the communication unit 109 of the information processing apparatus 101. Note also that the communication unit 156 may directly communicate with the information processing apparatus 101 by wireless communication, or may communicate with the information processing apparatus 101 via the access point 131. The communication unit 156 may include hardware functioning as an access point, or operate as an access point by software for causing the communication unit 156 to function as an access point. Note that in this embodiment, the communication unit 156 and the short distance wireless communication unit 157 are implemented by one radio chip. That is, in this embodiment, a combo chip corresponding to both a communication function based on the IEEE 802.11 communication standard and a communication function based on the short distance wireless communication method is used. However, the present invention is not limited to this form, and the communication unit 156 and the short distance wireless communication unit 157 may be implemented by separate radio chips.

The RAM 153 is formed by a DRAM or the like that needs a backup power supply. Note that the RAM 153 can store important data such as program control variables without volatilization because the data are held by power supply (not shown) for data backup. Furthermore, the RAM 153 is used as the main memory and work memory of the CPU 154, operates as a reception buffer for temporarily saving print information received from the information processing apparatus 101 or the like, and saves various kinds of information.

The ROM 152 stores permanent data such as control programs to be executed by the CPU 154, data tables, and an OS program. In this embodiment, the respective control programs stored in the ROM 152 perform software execution control such as scheduling, task switch, and interrupt processing under the management of the embedded OS stored in the ROM 152. In addition, a memory area that stores data necessary to be held even when no power is supplied, such as setting information of the communication apparatus 151 and management data of the communication apparatus 151, is also provided in the ROM 152.

The CPU 154 is a system control unit, and controls the overall communication apparatus 151. Based on the information saved in the RAM 153 or a print job received from the information processing apparatus 101 or the like, the print engine 155 forms an image on a print medium such as a paper sheet using a printing material such as ink and outputs the print result. At this time, the print job transmitted from the information processing apparatus 101 or the like has a large transmission data amount, and high-speed communication is required. Thus, the print engine 155 receives the print job via the communication unit 156 capable of performing communication at a higher speed than the short distance wireless communication unit 157.

The short distance wireless communication unit 157 is configured to be wirelessly connected to an apparatus such as the information processing apparatus 101 at a short distance and execute data communication, and perform communication by a communication method different from that of the communication unit 156. The short distance wireless communication method used in the short distance wireless communication unit 157 is, for example, Bluetooth® or NFC. Bluetooth may be Bluetooth Classic or Bluetooth Low Energy. The short distance wireless communication unit 157 can be connected to the short distance wireless communication unit 110.

The input interface 158 is an interface configured to accept a data input and an operation instruction from the user, and is formed by a physical keyboard, buttons, a touch panel, and the like. Note that the output interface 159 and the input interface 158 (to be described later) may have the same arrangement, and output of a screen and acceptance of an operation from the user may be done by the same arrangement. The output interface 159 is an interface that performs control for causing the operation display unit 160 to perform display of data and notification of the state of the communication apparatus 151.

The operation display unit 160 is formed by a display unit such as a Light-Emitting Diode (LED) or a Liquid Crystal Display (LCD), and performs display of data and notification of the state of the communication apparatus 151. Note that a software keyboard including keys such as numerical input keys, a mode setting key, an OK key, a cancel key, and a power key may be provided on the operation display unit 160 so that an input from the user is accepted via the operation display unit 160.

The scan control unit 161 includes an image sensor unit (reading unit) that executes scanning of a document set on a document table or an Automatic Document Feeder (ADF) (not shown). Note that the image sensor unit includes a light source configured to irradiate a document with light, and an image sensor having an array of elements configured to read the reflected light and photoelectrically convert it. The scan control unit 161 acquires image data by analog/digital (A/D)-converting an analog electrical signal obtained by reading a document by the image sensor unit. The scan control unit 161 also includes a circuit configured to perform direct memory access (DMA) transfer in order to store acquired image data in the RAM 153.

### <Direct Connection Method>

Direct connection indicates a form in which apparatuses are wirelessly connected directly (that is, by Peer to Peer) without intervention of an external apparatus such as the access point 131. As one connection mode, the communication apparatus 151 can operate in a mode (direct connection mode) for communication by direct connection. In Wi-Fi communication, the mode for communication by direct connection includes a plurality of modes such as a software AP mode and a Wi-Fi Direct® mode. Wi-Fi Direct will be referred to as WFD hereinafter.

A mode in which direct connection is executed by WFD is called a WFD mode. WFD is a standard developed by Wi-Fi Alliance and is a standard included in the IEEE 802.11 communication standards. In the WFD mode, a device serving as a communication partner is searched for by a device search command, then the roles of a P2P group owner (GO) and P2P client are decided, and remaining wireless connection processing is performed. The group owner corresponds to a Wi-Fi master station (master unit), and the client corresponds to a Wi-Fi slave station (slave unit). This role making corresponds to, for example, GO Negotiation in P2P. Note that in the WFD mode in a state before role making is performed, the communication apparatus 151 is neither the master station nor the slave station. More specifically, first, one of devices to communicate with each other issues device search information and searches for a device to be connected in the WFD mode. After the other device serving as a communication partner is found, the devices confirm information about services and functions that can be supplied by the respective devices. Note that the device supply information confirmation is an option and is dispensable. The device supply information confirmation phase corresponds to, for example, P2P Provision Discovery. Then, the devices confirm the device supply information and decide, as roles, which device serves as a P2P client and which device serves as a P2P group owner. After the client and the group owner are decided, the devices exchange parameters for performing WFD communication. Based on the exchanged parameters, the P2P client and the P2P group owner perform remaining wireless connection processing and IP connection processing. Note that in the WFD mode, the communication apparatus 151 may always operate as the GO without executing the above-described GO Negotiation. That is, the communication apparatus 151 may operate in the WFD mode that is an Autonomous GO mode. The state in which the communication apparatus 151 operates in the WFD mode is, for example, a state in which WFD connection is not established but the communication apparatus 151 operates as the GO, or a state in which WFD connection is established and the communication apparatus 151 operates as the GO.

In the software AP mode, one device (for example, the information processing apparatus 101) among devices (for example, the information processing apparatus 101 and the communication apparatus 151) to communicate with each other serves as a client that plays a role of requesting various services. The other device implements the function of an access point in Wi-Fi by software setting. The software AP corresponds to a Wi-Fi master station, and the client corresponds to a Wi-Fi slave station. In the software AP mode, the client searches for a device serving as a software AP by device search information. After the software AP is found, the client and the software AP perform remaining wireless connection processing (establishment of wireless connection and the like) and then IP connection processing (assignment of an IP address and the like). Note that commands and parameters transmitted/received when implementing wireless connection between the client and the software AP suffice to be those defined by the Wi-Fi standard, and a description thereof will be omitted here.

In this embodiment, in a case where the communication apparatus 151 establishes and maintains direct connection, it operates as a master station in a network to which the communication apparatus 151 belongs. Note that the master station is an apparatus that creates a wireless network, and is an apparatus that provides a slave station with parameters used in connection to the wireless network. The parameters used in connection to the wireless network are, for example, parameters about a channel used by the master station. The slave station receives the parameters and is then connected to the wireless network created by the master station using the channel used by the master station. In the direct connection mode, the communication apparatus 151 operates as the master station and can thus decide a specific frequency band and channel to be used for communication in the direct connection method. In this embodiment, the communication apparatus 151 can use a channel corresponding to the 2.4-GHz frequency band and a channel corresponding to the 5-GHz frequency band for communication in the direct connection method. Then, the user can arbitrarily set a specific frequency band to be used (that is, a channel in a specific frequency band to be used) by making a setting on a screen displayed by the communication apparatus 151. In this embodiment, however, even if 5 GHz is selected on the screen displayed by the communication apparatus 151, the communication apparatus 151 does not use a channel corresponding to the Dynamic Frequency Selection (DFS) band in the 5-GHz frequency band for communication in the direct connection mode. In other words, the communication apparatus 151 uses only a channel corresponding to a frequency band other than the DFS band in the 5-GHz frequency band for communication in the direct connection mode. Note that if a radar wave in the frequency band corresponding to the channel is detected in a state in which a channel corresponding to the DFS band is used, the channel currently used needs to be changed. The frequency band in which the channel can be changed by detecting a radar wave is called the DFS band. Note that if, for example, a radio chip corresponding to a DFS function is used, it may be possible to use a channel corresponding to the Dynamic Frequency Selection (DFS) band in the 5-GHz frequency band for communication in the direct connection mode.

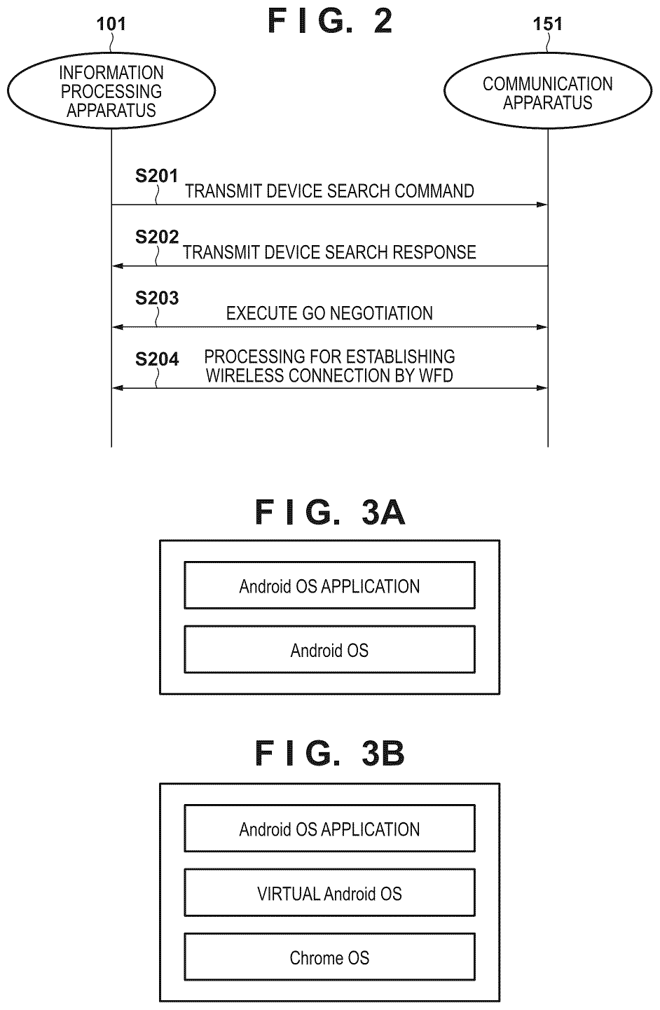

FIG. 2 is a sequence chart showing a wireless connection sequence in the WFD mode. Note that processing executed by each apparatus in this sequence is implemented when the CPU of each apparatus reads out various programs stored in the memory such as the ROM of each apparatus into the RAM and executes them. This processing is started when each apparatus accepts a predetermined operation for establishing WFD connection from the user in a state in which each apparatus activates a predetermined application for executing the WFD function. Note that the predetermined operation for establishing WFD connection is, for example, an operation of selecting a “direct connection mode enabling/disabling” button. Note that the operation corresponds to an operation for activating the direct connection mode.

First, in S201, the information processing apparatus 101 transmits device search information to search for an apparatus supporting the WFD function as a communication partner apparatus.

Subsequently, in S202, if the received device search information is information transmitted using the same channel as that currently used in the direct connection mode, the communication apparatus 151 transmits, to the information processing apparatus 101, a device search response as a response to the information. Thus, the information processing apparatus 101 finds the communication apparatus 151 as an apparatus supporting the WFD function. Note that after the information processing apparatus 101 finds the communication apparatus 151, processing of exchanging information concerning services and functions that can be supplied by the respective apparatuses may be performed between these apparatuses.

Subsequently, in S203, the information processing apparatus 101 and the communication apparatus 151 execute GO Negotiation. After the client and the group owner are decided, they exchange parameters for performing WFD communication. Based on the exchanged parameters, the P2P client and the P2P group owner perform remaining wireless connection processing and IP connection processing. Note that when the communication apparatus 151 operates in the Autonomous GO mode, the communication apparatus 151 may always operate as the GO without executing GO Negotiation, as described above. Furthermore, if the communication apparatus 151 operates as the GO, the communication apparatus 151 serves as the master station to decide a frequency band and a channel to be used for WFD communication. Therefore, the communication apparatus 151 operating as the GO can select which of the 5-GHz frequency band and the 2.4-GHz frequency band and which of channels corresponding to the decided frequency band.

After that, in S204, based on the exchanged parameters, the respective apparatuses use the channel decided by the GO to execute processing of establishing wireless connection by WFD.

### <Infrastructure Connection Method>

Infrastructure connection is a connection form in which devices (for example, the information processing apparatus 101 and the communication apparatus 151) to communicate with each other are connected to an access point (for example, the access point 131) that controls a network of the devices, and the devices communicate with each other via the access point. As one connection mode, the communication apparatus 151 can operate in a mode (infrastructure connection mode) for communication by infrastructure connection.

In infrastructure connection, each device searches for an access point by device search information. After an access point is found, the device and the access point perform remaining wireless connection processing (establishment of wireless connection and the like) and then IP connection processing (assignment of an IP address and the like). Note that commands and parameters transmitted/received when implementing wireless connection between the device and the access point suffice to be those defined by the Wi-Fi standard, and a description thereof will be omitted here.

In this embodiment, when the communication apparatus 151 operates in the infrastructure connection mode, the access point 131 operates as a master unit and the communication apparatus 151 operates as a slave unit. That is, in this embodiment, infrastructure connection means connection between the communication apparatus 151 operating as a slave unit and the apparatus operating as a master unit. In a case where the communication apparatus 151 establishes infrastructure connection and the information processing apparatus 101 also establishes infrastructure connection to the access point 131, the communication apparatus 151 and the information processing apparatus 101 can communicate with each other via the access point 131. Since the access point 131 decides a channel to be used for communication in infrastructure connection, the communication apparatus 151 executes communication in infrastructure connection using the channel decided by the access point 131. In this embodiment, the communication apparatus 151 can use a channel corresponding to the 2.4-GHz frequency band and a channel corresponding to the 5-GHz frequency band for communication in infrastructure connection. Note that the communication apparatus 151 can also use a channel corresponding to the DFS band in the 5-GHz frequency band for communication in infrastructure connection. Note also that to communicate with the communication apparatus 151 via the access point 131, the information processing apparatus 101 needs to recognize that the communication apparatus 151 belongs to a network which is formed by the access point 131 and to which the information processing apparatus 101 belongs. Furthermore, in a case where the information processing apparatus 101 and the communication apparatus 151 are connected to the access point 131 by infrastructure connection, the communication apparatus 151 can be found by broadcast executed by the information processing apparatus 101.

### <Network Setup Mode>

The communication apparatus 151 can operate in the network setup mode. A trigger for the communication apparatus 151 to start an operation in the network setup mode may be, for example, the pressing of a network setup mode button by the user or activation (power-on) of the communication apparatus 151 for the first time after arrival. The network setup mode button may be a hardware (physical) button of the communication apparatus 151 or a software button displayed on the display unit 158 by the communication apparatus 151.

When the communication apparatus 151 starts an operation in the network setup mode, it enables Wi-Fi communication. More specifically, as Wi-Fi communication enabling processing, the communication apparatus 151 enables an internal AP (connection setting AP) of the communication apparatus 151 that is dedicated to the network setup mode. Then, the communication apparatus 151 can establish Wi-Fi direct connection to the information processing apparatus 101. Assume that connection information (Service Set Identifier (SSID) and password) for connection to the connection setting AP is held in advance in the setup application installed in the information processing apparatus 101, and the information processing apparatus 101 recognizes in advance the connection information for connection to the connection setting AP. Therefore, unlike connection information of an AP enabled in the direct connection mode, the connection information for connection to the connection setting AP cannot be changed arbitrarily by the user. Note that in the network setup mode, the communication apparatus 151 may be connected to the information processing apparatus 101 by not normal Wi-Fi but Wi-Fi Direct (WFD). That is, the communication apparatus 151 may operate as a group owner, and receive a setting command from the information processing apparatus 101 by WFD communication. Alternatively, the communication apparatus 151 may be connected to the information processing apparatus 101 by Bluetooth in the network setup mode. Bluetooth includes Bluetooth Classic and Bluetooth Low Energy (BLE). That is, for example, the communication apparatus 151 may operate as a slave apparatus in BLE in the network setup mode, and receive a setting command from the information processing apparatus 101 by BLE communication. Furthermore, in the network setup mode, the communication apparatus 151 may be able to execute both a network setup by Wi-Fi and a network setup by BLE. That is, when the communication apparatus 151 starts an operation in the network setup mode, it may enable both Wi-Fi communication and BLE communication. More specifically, when the communication apparatus 151 starts an operation in the network setup mode, it may enable both the connection setting AP and an advertising state in which BLE connection is enabled by transmitting advertising information by BLE.

When the communication apparatus 151 operates in the network setup mode, it controls the communication unit 156 to operate as a network setup access point (connection setting AP or setup access point) that is enabled only during an operation in the network setup mode. The setup access point is an access point different from that enabled in the above-described software AP mode. Assume that the SSID of the setup access point includes a predetermined character string recognizable by the setup application of the information processing apparatus 101.

Assume that the communication apparatus 151 operating in the network setup mode uses a predetermined communication protocol (setup communication protocol) in communication with the information processing apparatus 101 connected to the setup access point. More specifically, the setup communication protocol is, for example, Simple Network Management Protocol (SNMP).

If a predetermined time elapses after the communication apparatus 151 starts an operation in the network setup mode, the communication apparatus 151 stops the operation in the network setup mode and disables the setup access point. Furthermore, even when the connection information for connection to the access point 131 and a change instruction of the wireless communication operation mode are received from the information processing apparatus 101 in the network setup mode, the setup access point is disabled. Assume that the setup access point is an access point that does not require a password for connection. Note that the setup access point may be an access point that requires a password. In this case, a password used for connection to the setup access point is a fixed password (unchangeable by the user) that is grasped in advance by the setup application.

### <Software Configuration of Information Processing Apparatus 101>

Next, the software configuration of the information processing apparatus 101 according to this embodiment will be explained. FIG. 3A shows an example of the software configuration of the information processing apparatus 101 when a host OS operating on the information processing apparatus 101 is the Android OS (first OS). In this form, an application for the Android OS operates on the Android OS. In this form, the software configuration of the information processing apparatus 101 does not include the Chrome OS. An environment where an OS operating on the lowest layer of the information processing apparatus 101 is the Android OS (not the Chrome OS), like this form, will be referred to as the first environment hereinafter. More specifically, the first environment is, for example, an environment where a host OS is installed in the information processing apparatus 101 but no guest OS is installed, and an application operates on the host OS. Furthermore, more specifically, the first environment is, for example, an environment where both a host OS and a guest OS are installed in the information processing apparatus 101, and an application operating in this embodiment operates on the host OS and operates without intervention of the guest OS (does not operate on the guest OS).

FIG. 3B shows an example of the software configuration of the information processing apparatus 101 when a host OS operating on the information processing apparatus 101 is the Chrome OS (second OS). In this form, a virtual Android OS serving as a virtual OS operates on the Chrome OS. An application for the Android OS operates on the virtual Android OS. An environment where an OS operating on the lowest layer of the information processing apparatus 101 is the Chrome OS and the virtual Android OS operates on the Chrome OS, like this form, will be referred to as the second environment hereinafter. Note that in this embodiment, a virtual OS is a program for operating, on a host OS, an application not corresponding to the host OS, and is a guest OS. Note that the virtual OS may be a whole existing OS such as the Android OS, an OS obtained by omitting some modules from a whole existing OS, or a program created separately from an existing OS. The virtual OS is implemented by, for example, a virtualization technique such as a Virtual Machine system or a container system.

A problem generated when an application for the Android OS is operated in the second environment will be explained below.

The process may be transferred from the application for the Android OS to another software. For example, assume a case where the application for the Android OS is a setup application for performing a network setup, and the process is transferred to the OS to connect the information processing apparatus 101 to an external access point. The external access point corresponds to, for example, an access point in the printer in the network setup mode.

Assume that a screen (to be referred to as an application screen hereinafter) displayed by the setup application in the first environment is displayed on the foreground. If the process is transferred to the OS, a screen (to be referred to as an OS screen hereinafter) displayed by the OS standard application is displayed to overlap the foreground in a window of the application screen. That is, the OS screen is displayed on the foreground and the application screen is displayed on the background. Note that the OS screen may not be a screen that is displayed on the entire display of the information processing apparatus 101, and may be a dialog displayed on a part of the display. Similar to the host OS, the OS standard application is the OS standard application installed in advance in the information processing apparatus 101 at the time of arrival of the information processing apparatus 101. In other words, the OS standard application is an application that is not installed by a store application as an application for installing various kinds of applications in the information processing apparatus 101 via the Internet. Note that the OS standard application can be considered as a part of the host OS. If the display of the OS screen ends in this state, the application screen is displayed again on the foreground, and the OS notifies the application that the display of the application screen has returned to the foreground. Then, the setup application executes, based on the notification that the display of the application screen has returned from the background to the foreground, processing of determining the external access point to which the information processing apparatus 101 is connected, and executes network setup processing for the printer.

On the other hand, assume that the application screen is displayed on the foreground in the second environment. The second environment is an environment corresponding to a multiwindow function. The multiwindow function is a function of displaying a plurality of windows simultaneously (at the same time) on the screen of the information processing apparatus 101. Therefore, if the process is transferred to the OS at this time, the OS screen may be displayed by a window that is different from a window displaying the application screen and is displayed in a region different from a region where the window displaying the application screen is displayed. That is, even if the OS screen is displayed based on a user operation on the application screen, the application screen may remain displayed on the foreground and may not transition to the background. Therefore, even when the display of the OS screen ends, the OS does not notify the setup application that the display has returned to the foreground. Thus, the setup application does not receive a notification from the OS, and cannot start subsequent predetermined processing, for example, network setup processing.

To cope with this, in this embodiment, if the application for the Android OS transfers the process to the OS, and executes predetermined processing based on information acquired from the OS, it is determined whether the setup application operates in the first environment or the second environment. If it is determined that the setup application operates in the second environment, the setup application inquires of the OS about information to be used for subsequent predetermined processing at a predetermined time interval without waiting for the above-described notification from the OS. Then, the setup application executes processing of determining the external access point to which the information processing apparatus 101 is connected. With this configuration, even in the second environment, the setup application can start the subsequent predetermined processing, for example, the network setup processing.

The problem will further be described.

If the process is transferred to the OS in a state in which the application screen is displayed on the foreground in the second environment, as described above, the OS screen is displayed in a window different from a window displaying the application screen, and the application screen remains displayed on the foreground. That is, the user can perform an operation not only on the OS screen but also on the application screen. On the other hand, if the process is transferred to the OS in a state in which the application screen is displayed on the foreground in the first environment, the OS screen is displayed on the foreground and the application screen is displayed on the background. In this state, the user cannot perform an operation on the application screen.

Because of the configuration of the setup application, it is not assumed that the setup application accepts a user operation on the application screen when it transfers the process to the OS and stands by for a result of processing by the OS. Therefore, if an unexpected user operation is accepted at the timing, the “OS processing standby” state of the setup application is unwantedly canceled. As a result, it is impossible to start the subsequent predetermined processing, for example, network setup processing.

To cope with this, in this embodiment, if the application for the Android OS transfers the process to the OS, and executes predetermined processing based on information acquired from the OS, it is determined whether the setup application operates in the first environment or the second environment. If it is determined that the setup application operates in the second environment, the setup application transfers the process to the OS, and then performs display control of the application screen so as not to be able to accept a user operation. With this configuration, it is possible to prevent a situation in which an unexpected user operation is accepted and it is thus impossible to start the subsequent predetermined processing, for example, network setup processing.

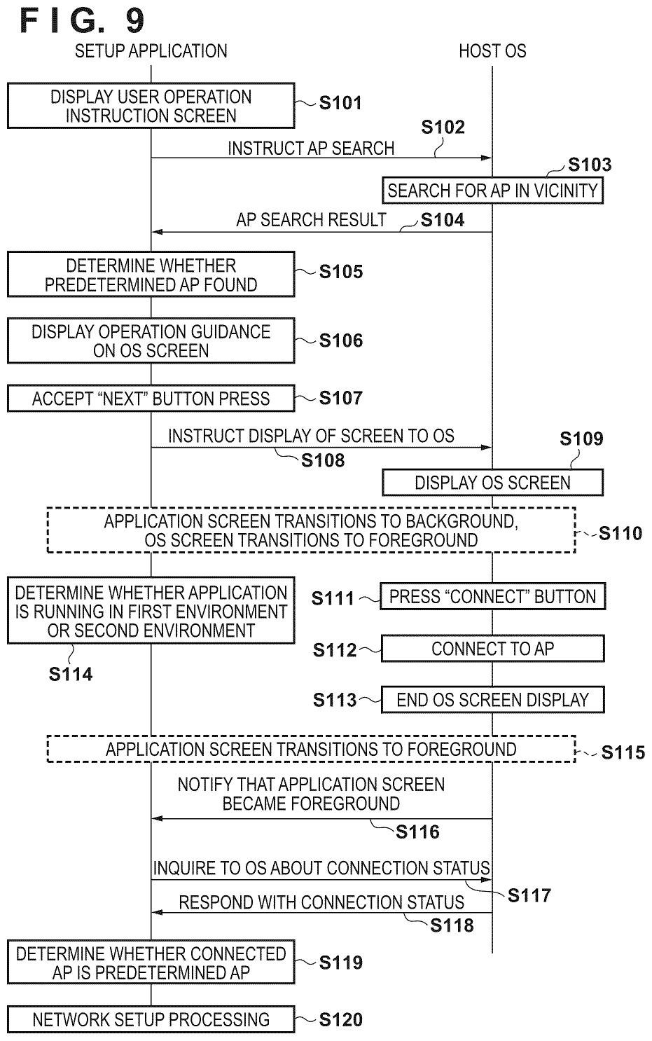

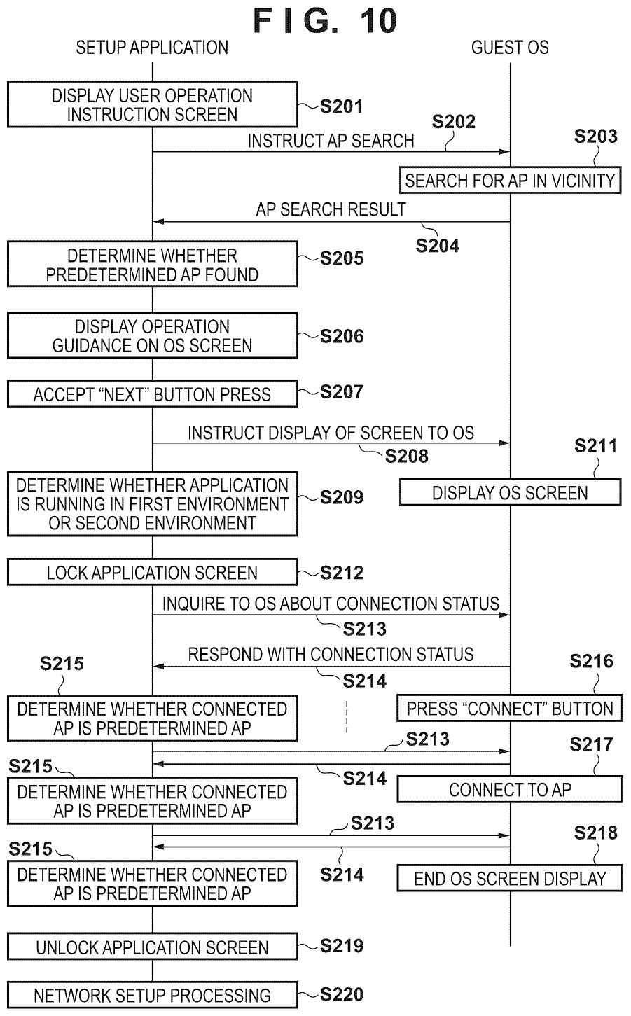

First, a case where the information processing apparatus 101 operates in the above-described first environment will be described. FIG. 9 is a sequence chart showing sequence processing between the setup application and the host OS in the first environment. The host OS is, for example, the Android OS shown in FIG. 3A.

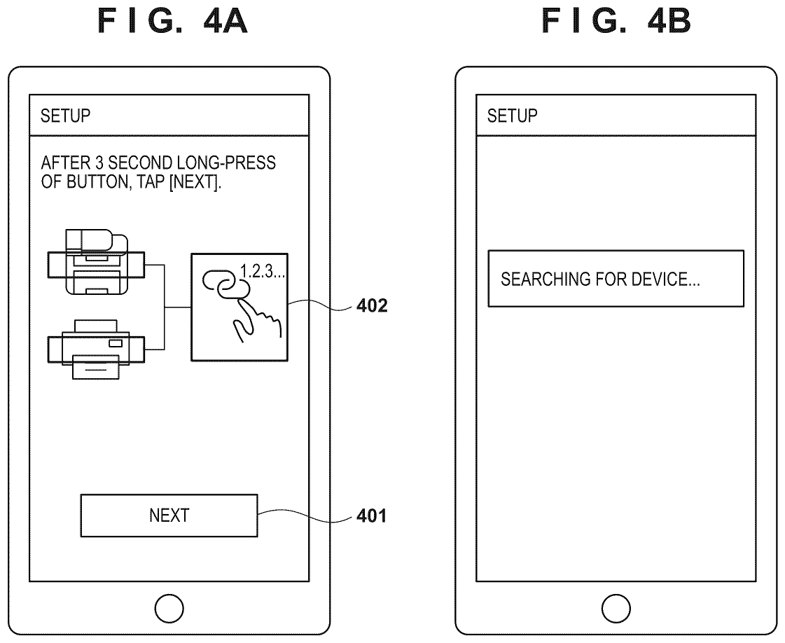

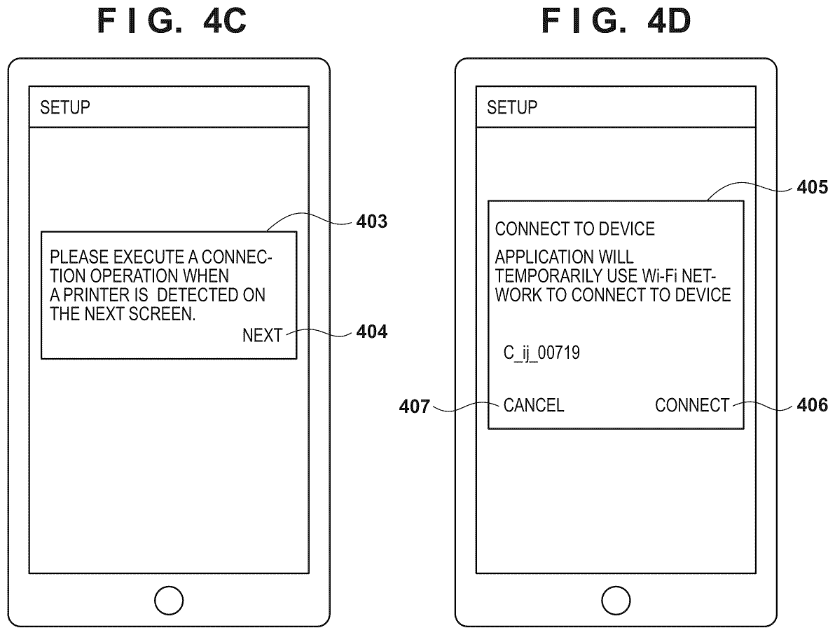

In S101, the setup application displays a user operation instruction screen. The user operation instruction screen is a screen displayed by the setup application. In this embodiment, the setup application is an application for performing a network setup of the communication apparatus 151. FIG. 4A is a view showing an example of the user operation instruction screen displayed in S101. On the user operation instruction screen, an operation procedure 402 for shifting the state of the communication apparatus 151 to the network setup mode is displayed. For example, as shown in FIG. 4A, a message for prompting to long-press a button on the communication apparatus 151 for 3 sec is displayed. If the button for shifting to the network setup mode is operated in accordance with the operation procedure, the communication apparatus 151 shifts to the network setup mode. More specifically, for example, the CPU 154 causes the communication unit 156 to operate as a setup access point that is enabled only during an operation in the network setup mode. After performing an operation in accordance with the operation procedure 402, the user presses a next button 401. If the setup application displays the user operation instruction screen in S101, the setup application internally stores connection information (SSID and the like) to the currently connected external access point.

Upon accepting the pressing of the next button 401 on the user operation instruction screen shown in FIG. 4A, the setup application instructs, in S102, the host OS to execute a search for an external access point (external AP). If execution of a search for an external AP is instructed, a searching screen shown in FIG. 4B is displayed on the operation display unit 108.

In S103, upon accepting the instruction to search for an external AP from the setup application, the host OS executes a search for an external AP in the vicinity. In S104, the host OS notifies the setup application of information (search result) of a found external AP as a result of the search for the external AP. The information of the external AP is, for example, an SSID. In S104, for example, the setup application is notified of information of an external AP found first.

In S105, the setup application determines, based on the search result notified from the host OS, whether a predetermined AP has been found. The predetermined AP is a setup access point, and the setup application recognizes in advance a character string for identifying the setup access point. In this example, assume that it is determined that the predetermined AP has been found.

In S106, the setup application displays an operation guidance screen for displaying guidance on an operation to be performed by the user on the OS screen to be displayed next. FIG. 4C is a view showing an example of the operation guidance screen displayed in S106. As shown in FIG. 4C, on the operation guidance screen, “please execute a connection operation when a printer is detected on the next screen” is displayed, and a dialog including a message 403 for prompting to perform an operation on the OS screen is displayed. Note that the dialog including the message 403 is displayed in a window displaying the application screen. Therefore, although not shown, the application screen (for example, the screen shown in FIG. 4A or 4B) that is immediately precedingly displayed is thinly displayed behind the dialog including the message 403. The dialog including the message 403 is not a dialog displayed via the OS standard application but a dialog displayed by the setup application. In other words, text displayed as the message 403 is decided by the setup application. The setup application accepts, in S107, the pressing of a next button 404 on the operation guidance screen, and instructs, in S108, the host OS to display the OS screen. Then, in S109, the host OS displays, by the OS standard application, the OS screen that can accept an instruction to perform connection to the found external AP. FIG. 4D is a view showing an example of the OS screen displayed in S109. Note that the OS screen is displayed in the window displaying the application screen.

At the time of S110, the application screen is displayed on the background and the OS screen is displayed on the foreground. More specifically, for example, the OS screen is displayed to overlap the foreground in a window of the application screen, and the user cannot perform an operation on the application screen. As shown in FIG. 4D, a message 405 including identification information of the found external AP is displayed on the OS screen. Note that the identification information is, for example, an SSID. Furthermore, a connection button 406 and a cancel button 407 are displayed on the OS screen, and can be pressed by the user. As described above, the OS screen is a dialog displayed by the OS standard application. In other words, text displayed as the message 405 and text displayed on the connection button 406 and the cancel button 407 are decided by the OS standard application.

In S111, the host OS accepts the pressing of the connection button 406 on the OS screen. In S112, the host OS disconnects the currently connected external AP, and performs connection to the external AP for which the connection instruction has been accepted on the OS screen. In S113, the host OS ends the display of the OS screen.

On the other hand, in S114, the setup application determines whether the application itself operates in the first environment or the second environment. More specifically, for example, the setup application inquires of the host OS about the operating environment using an Application Programming Interface (API), and performs determination based on the result of the inquiry. Since it is assumed here that the application operates in the first environment, it is determined that the setup application operates in the first environment. The determination processing in S114 is executed at a timing after S110 in FIG. 9 but may be executed at a timing before S110.

If the display of the OS screen ends in S113, the host OS returns the application screen to the foreground in S115. Then, in S116, the host OS notifies the setup application that the application screen has returned to the foreground.

In S117, based on the notification that the application screen has returned to the foreground, the setup application inquires of the host OS about the connection status of the information processing apparatus 101 to the external AP. In response to the inquiry in S117, the host OS transmits, in S118, to the setup application, the connection status to the external AP. The connection status to the external AP is information concerning the external AP (to be referred to as the connected AP hereinafter) to which the information processing apparatus 101 is connected, and is, for example, an SSID. If there is no connected AP, information indicating that there is no connected AP is transmitted as the connection status.

In S119, the setup application determines whether the connected AP is a predetermined AP. In this example, it is determined whether the connected AP is the setup access point. Based on the known SSID of the setup access point, the setup application performs the determination processing in S119. If it is determined that the connected AP is the setup access point, the setup application executes, in S120, network setup processing for the communication apparatus 151. At this time, the application screen transitions to a screen of the network setup processing. The network setup processing will be described later with reference to FIG. 11.

As described above, in this embodiment, if the information processing apparatus 101 operates in the first environment, the setup application determines, based on the notification, from the host OS, that the application screen has returned to the foreground, whether the external AP to which the information processing apparatus 101 is connected is the setup access point. More specifically, upon receiving, from the host OS, the notification that the application screen has returned to the foreground, the setup application inquires of the host OS about the SSID of the external AP to which the information processing apparatus 101 is connected. Then, if it is determined that the external AP to which the information processing apparatus 101 is connected is the setup access point, network setup processing is executed for the communication apparatus 151.

Next, a case where the information processing apparatus 101 operates in the above-described second environment will be described. FIG. 10 is a sequence chart showing sequence processing between the setup application and the guest OS in the second environment. The guest OS is, for example, the virtual Android OS shown in FIG. 3B.

S201 to S205 are the same as S101 to S105 of FIG. 9 and a description thereof will be omitted.

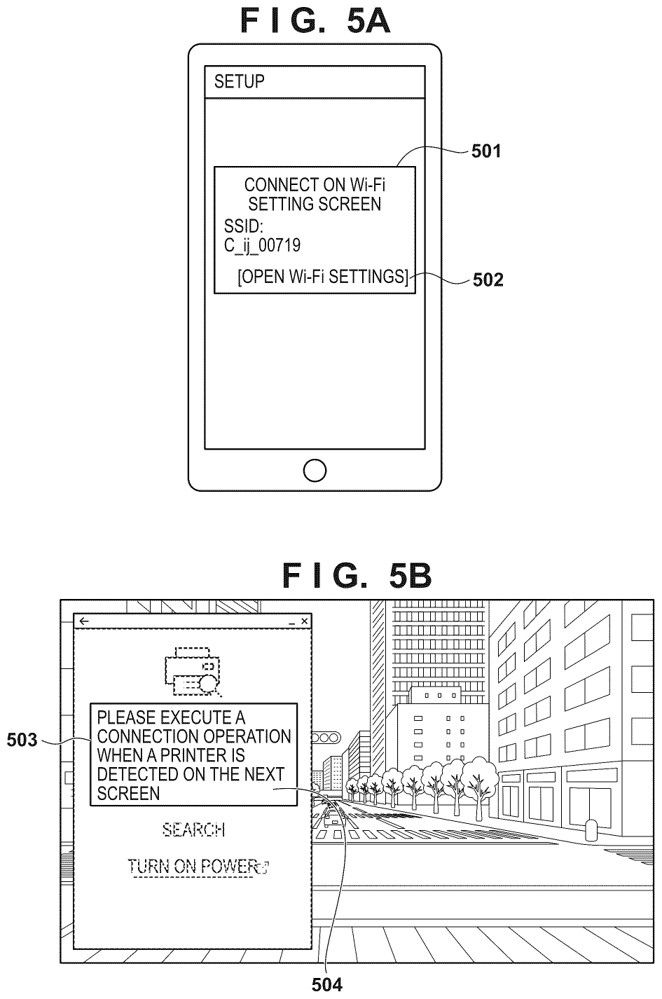

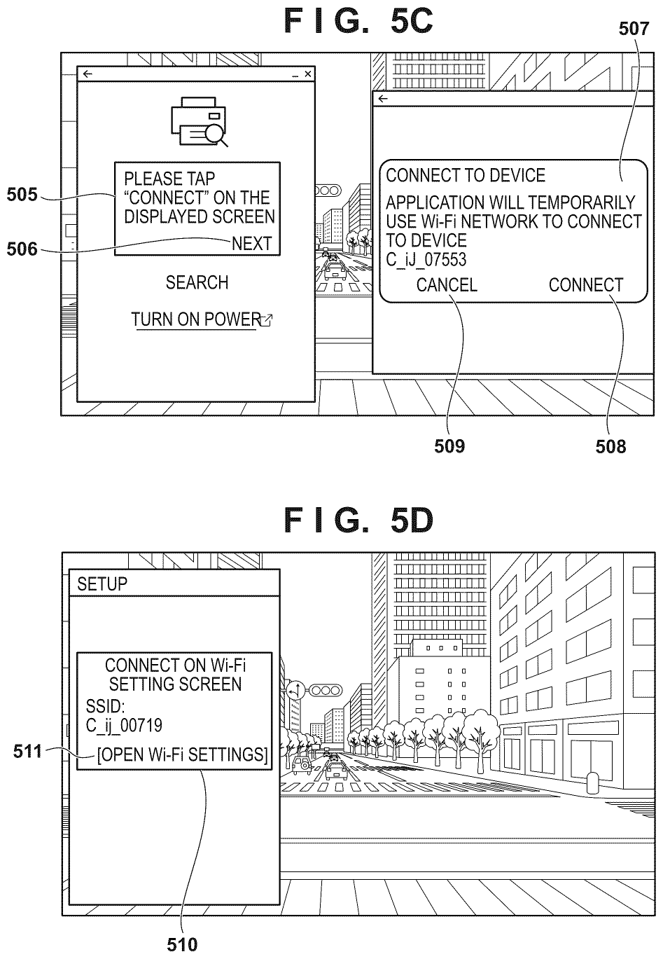

In S206, the setup application displays an operation guidance screen for guiding an operation to be executed by the user on the OS screen to be displayed next. FIG. 5B is a view showing an example of the operation guidance screen displayed in S206. As shown in FIG. 5B, on the operation guidance screen, guidance 503 of “please execute a connection operation when a printer is detected on the next screen” and a “next” button 504 are displayed. Note that the application screen that is immediately precedingly displayed is thinly displayed behind the window displaying the guidance 503. The setup application accepts, in S207, the pressing of the “next” button 504 on the operation guidance screen, and instructs, in S208, the guest OS to display the screen.

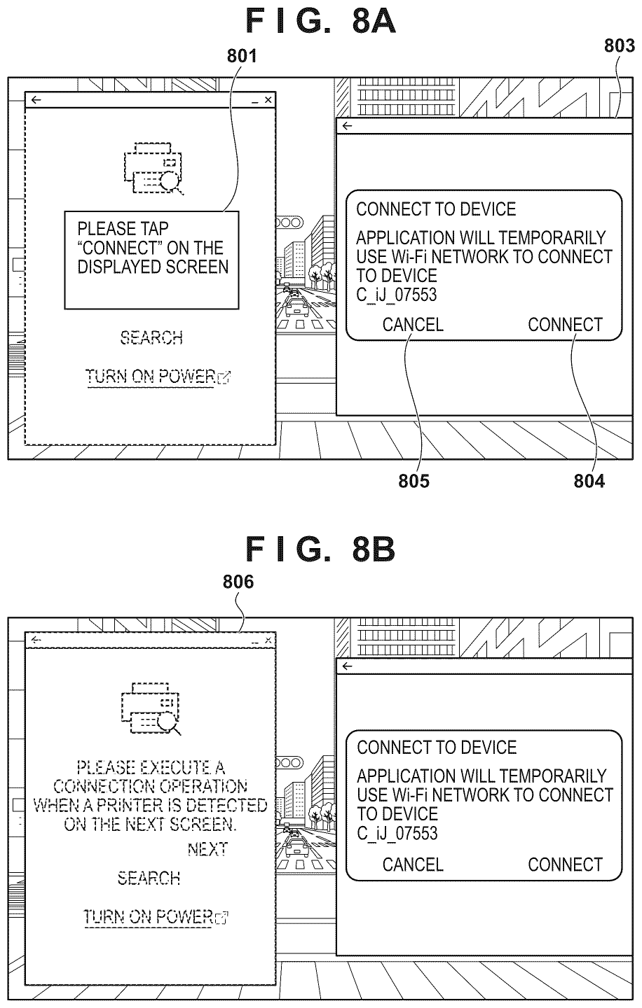

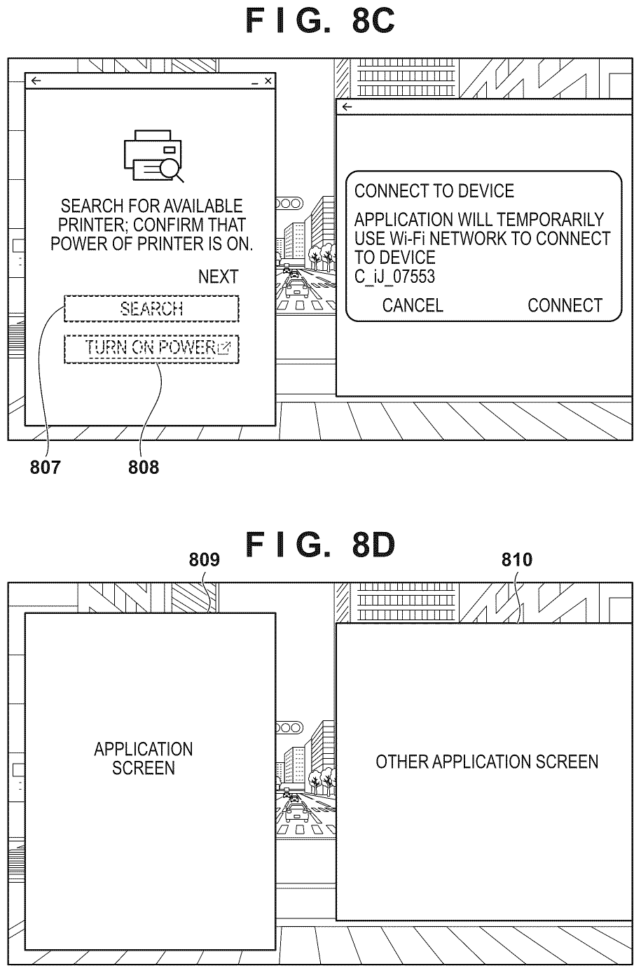

In S211, the guest OS displays, by the OS standard application, the OS screen that can accept an instruction to perform connection to the found external AP. If the information processing apparatus 101 operates in the second environment, the OS screen is displayed, in parallel with the window of the application screen, in a window different from that of the application screen (in this example, the operation guidance screen). An OS screen 803 shown in FIG. 8A is an example of the OS screen displayed in S211. As shown in FIG. 8A, a message including the identification information of the found external AP is displayed on the OS screen 803. Note that the identification information is, for example, an SSID. In addition, a connection button 804 and a cancel button 805 are displayed on the OS screen 803, and can be pressed by the user. Upon accepting the pressing of the connection button 804 on the OS screen 803 in S216, the guest OS disconnects, in S217, the currently connected external AP and performs connection to the external AP for which the connection instruction has been accepted on the OS screen. In S218, the guest OS ends the display of the OS screen 803.

On the other hand, in S209, the setup application determines whether the application itself operates in the first environment or the second environment. More specifically, for example, the setup application inquires of the guest OS about the operating environment using an API, and performs determination based on the result of the inquiry. Since it is assumed here that the application operates in the second environment, it is determined that the setup application operates in the second environment.

In S212, the setup application controls the currently displayed application screen not to accept a user operation. Note that the currently displayed application screen is more specifically the operation guidance screen. This control will be referred to as a screen lock hereinafter. FIGS. 8A to 8C are views each showing an example of controlling the form of the display of the application screen. More specifically, for example, as shown in FIG. 8A, the setup application displays a dialog 801 on the operation guidance screen to give the user guidance on an operation to be executed on the screen other than the application screen. For example, by displaying, on the foreground in the window of the application screen, a dialog of, for example, “please tap “connect” on the displayed screen” for presenting an operation to be executed on the OS screen displayed in the window different from that of the application screen, it becomes impossible to accept a user operation on the operation guidance screen. Note that even if an operation is performed on the dialog 801, the setup application executes nothing. For example, as shown in FIG. 8B, it may be indicated that any user operation is impossible, by changing the tint of an entire application screen 806 (for example, graying out the entire application screen 806). Alternatively, for example, as shown in FIG. 8C, by changing the tint of buttons 807 and 808 (for example, graying out the buttons 807 and 808) on the application screen displayed immediately before the guidance 503, it may be impossible to accept any user operation. For example, the button 808 is a link for displaying a Web manual, and is originally a button that is not expected to be pressed by the user while the application is in the OS processing standby state.

In a case where the information processing apparatus 101 operates in the first environment, the OS screen is superimposed and displayed on the application screen, and thus the user cannot perform an operation on the application screen. On the other hand, in a case where the information processing apparatus 101 operates in the second environment, the OS screen is displayed in a window different from a window displaying the application screen, and the window displaying the application screen and the window displaying the OS screen are displayed in parallel. Therefore, although the OS screen is displayed and an operation is to be executed on the OS screen, the user can press any button on the application screen. However, the setup application is not configured by assuming that a user operation is accepted at a timing of an external AP connection standby state (that is, the OS processing standby state) when the OS screen is displayed. Therefore, if an unexpected user operation is accepted at this timing, the “external AP connection standby” state of the setup application is canceled, and it is thus impossible to start the subsequent network setup processing. To cope with this, in this embodiment, it is possible to prevent an unexpected user operation from being accepted, by performing display control of the application screen so as not to be able to accept a user operation.

Note that control executed in S212 is not limited to the above form. For example, the operation guidance screen remains displayed on the foreground without displaying the dialog 801 but such control may be performed that the setup application does not execute any processing even if an operation is performed on the operation guidance screen. That is, more specifically, for example, such control may be performed that the setup application does not execute any processing even if the “next” button 504 is pressed. Alternatively, for example, control may be performed not to accept a user operation on the operation guidance screen by, for example, graying out the “next” button 504 without displaying the dialog 801.

In S213, the setup application inquires of the guest OS about the connection status of the information processing apparatus 101 to the external AP. In response to the inquiry in S213, the guest OS transmits, in S214, to the setup application, the connection status to the external AP. The connection status to the external AP is information concerning the external AP (connected AP) to which the information processing apparatus 101 is connected, and is, for example, an SSID. If there is no connected AP, information indicating that there is no connected AP is transmitted as the connection status. In S215, the setup application determines whether the connected AP is a predetermined AP. In this example, it is determined whether the connected AP is the setup access point. Based on the known SSID of the setup access point, the setup application performs the determination processing in S215. Note that if there is no connected AP, information indicating it is transmitted to the setup application in S214.

In this embodiment, the processes of S213 to S215 are performed at a predetermined time interval. More specifically, for example, the processes of S213 to S215 are performed for a specific time (for example, 30 sec) at an interval of 100 ms. As described above, in the second environment, the guest OS does not transmit the notification in S116 of FIG. 9, and thus the inquiry in S213 is repeatedly performed for the guest OS.

In FIG. 10, the processes of S213 to S215 are performed at a timing before S216, a timing between S216 and S217, and a timing between S217 and S218. If the processes of S213 to S215 are performed before S216, the information processing apparatus 101 has not been connected to the external AP in S215, and it is thus determined that the connected AP is not the setup access point. In this case, the processes of S213 to S215 are repeated. If the processes of S213 to S215 are performed at a timing between S216 and S217, the information processing apparatus 101 has not been connected to the external AP in S215, and it is thus determined that the connected AP is not the setup access point. In this case, the processes of S213 to S215 are repeated. If the processes of S213 to S215 are performed at a timing between S217 and S218, the information processing apparatus 101 has been connected to the external AP in S215. Therefore, it is determined that the connected AP is the setup access point, and the process advances to S219.

The setup application cancels, in S219, the display control in S212, and executes, in S220, the network setup processing for the communication apparatus 151. At this time, the setup application controls the currently displayed application screen to accept a user operation. More specifically, for example, the setup application ends the display of the application screen shown in each of FIGS. 8A to 8C, and displays the screen of the network setup processing. The network setup processing will be described later with reference to FIG. 11.

As described above, in this embodiment, if the information processing apparatus 101 operates in the second environment, the setup application displays the operation guidance on the OS screen, and then performs display control of the application screen so as not to be able to accept a user operation. This can prevent a situation in which an unexpected user operation is accepted and it is thus impossible to start the network setup processing. After performing the display control, the setup application inquires, at a predetermined time interval, of the guest OS about the external AP to which the information processing apparatus 101 is connected. Thus, even in a configuration in which the notification that the application screen has returned to the foreground is not received from the OS, it is possible to start the subsequent network setup processing.

FIG. 11 is a flowchart illustrating the network setup processing executed in S120 and S220. The processing shown in FIG. 11 is executed as processing of the setup application, and is implemented when the CPU 103 reads out programs stored in the ROM 104 into the RAM 105 and executes them.

In step S301, the CPU 103 requests, from the communication apparatus 151, a list (access point list) of access points via Wi-Fi connection between the information processing apparatus 101 and the communication apparatus 151 operating in the network setup mode.

In step S302, the CPU 103 acquires the access point list via the Wi-Fi connection between the information processing apparatus 101 and the communication apparatus 151 operating in the network setup mode. Note that the acquired access point list is a list indicating one or a plurality of access points connectable to the communication apparatus 151, which have been found by executing an AP search by the communication apparatus 151.

In step S303, the CPU 103 determines whether the access point list acquired in step S302 includes a connected AP to which the information processing apparatus 101 performs connection. The connected AP is, for example, information of the AP stored in S101 or S201. Since the access point list acquired in step S302 includes only access points connectable to the communication apparatus 151, a case where the acquired list includes the connected AP is a case where the communication apparatus 151 is connectable to the connected AP. A case where the acquired list includes no connected AP is a case where the communication apparatus 151 is not connectable to the connected AP. For example, since an access point that is connectable by an encryption method not corresponding to the communication apparatus 151 is not connectable to the communication apparatus 151, this access point is not included in the list. Since an access point that is connectable by a frequency band not corresponding to the communication apparatus 151 is not connectable to the communication apparatus 151, this access point is not included in the list. If it is determined in step S303 that the connected AP is not included, the process advances to step S306.

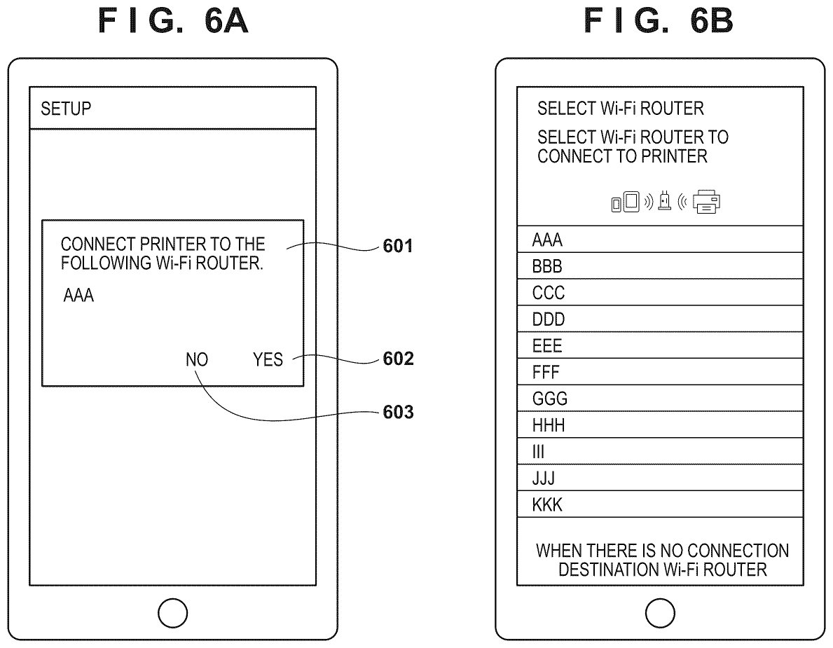

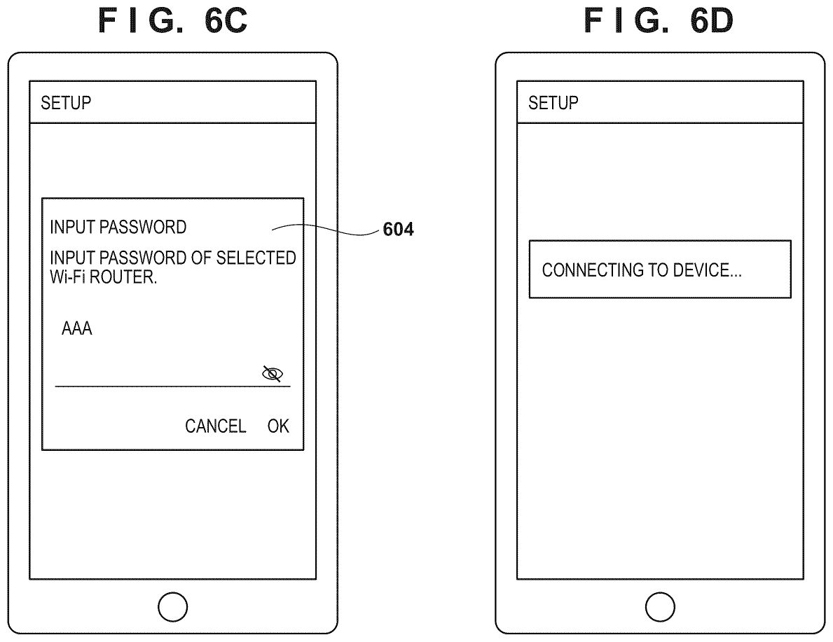

The CPU 103 displays, in step S306, the list acquired in step S302, and accepts, in step S307, selection of one of the access points of the list from the user. FIG. 6B is a view showing an example of a screen displayed in step S306. As shown in FIG. 6B, a list of SSIDs is displayed on the screen. Then, the CPU 103 decides, as a connection destination AP of the communication apparatus 151, the access point whose selection has been accepted from the user.

In step S308, the CPU 103 displays a screen for accepting input of a password for connection to the access point whose selection has been accepted from the user. FIG. 6C is a view showing an example of the screen displayed in step S308. As shown in FIG. 6C, a region for accepting input of a password is displayed on a screen 604.

In step S309, the CPU 103 transmits connection information including the password whose input has been accepted in step S308. Note that the connection information is information for connection to the access point, and includes, for example, the SSID and password. After transmitting the connection information, the CPU 103 displays a screen indicating that connection to the device is in progress, as shown in FIG. 6D. The communication apparatus 151 notifies, via the Wi-Fi connection between the information processing apparatus 101 and the communication apparatus 151 operating in the network setup mode, the information processing apparatus 101 that it has received the connection information. Then, the communication apparatus 151 attempts to perform connection to the access point corresponding to the connection information using the connection information received from the information processing apparatus 101. If connection succeeds, the communication apparatus 151 can execute communication via a network formed by the connected access point.

In step S310, the CPU 103 performs connection to the access point. In step S310, for example, using the connection information stored in S101 of FIG. 9 or S201 of FIG. 10, the setup application performs reconnection to the access point to which the information processing apparatus 101 has been connected. Note that the present invention is not limited to this form. For example, if the information processing apparatus 101 transmits, to the communication apparatus 151, connection information of another access point different from the access point to which the information processing apparatus 101 has been connected by Wi-Fi, the CPU 103 may perform connection to the other access point.

In step S311, the CPU 103 searches for the communication apparatus 151 on the network to which the self-apparatus belongs, determines whether the communication apparatus 151 has been found, and determines, based on the determination result, whether the network setup processing has succeeded. Note that the network to which the self-apparatus belongs is the network of the access point connected in step S310. If it is determined that the communication apparatus 151 has been found and it is thus determined that the network setup processing has succeeded, the process advances to step S312.

In step S312, the CPU 103 requests capability information from the communication apparatus 151. Upon receiving the request from the information processing apparatus 101, the communication apparatus 151 transmits the capability information to the information processing apparatus 101. The CPU 103 registers information of the communication apparatus 151 in the setup application, and can transmit a print job to the communication apparatus 151 by the setup application. Note that at this time, if the information processing apparatus 101 belongs to the network formed by the access point to which the communication apparatus 151 is connected by the network setup processing, the information processing apparatus 101 can execute communication with the communication apparatus 151 via the access point. Note that if the information processing apparatus 101 and the communication apparatus 151 cannot communicate with each other, for example, if the access point to which the communication apparatus 151 is connected is not the access point to which the information processing apparatus 101 is connected, the request and acquisition of the capability information are omitted. Note that for example, a communication protocol different from a setup communication protocol may be used for communication in step S312.

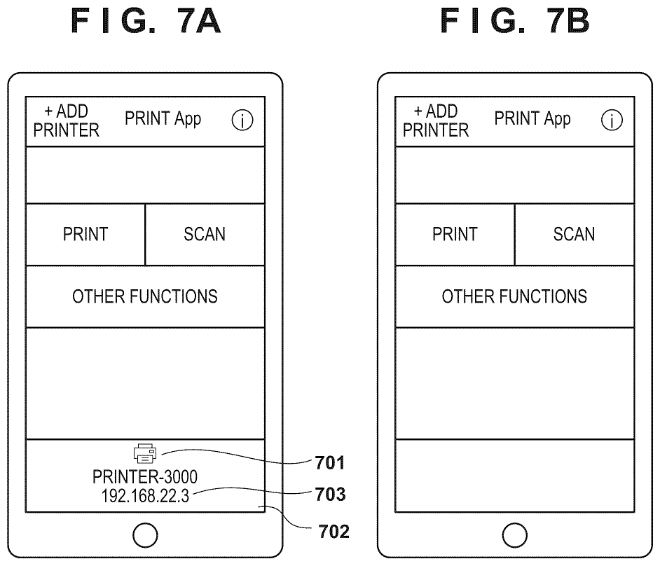

In step S313, the CPU 103 displays an application basic screen. As shown in FIG. 7A, information (IP address and the like) of the communication apparatus 151 registered in step S312 is displayed on the displayed application basic screen. If it is determined in step S311 that the network setup processing has failed, the CPU 103 displays the application basic screen in step S313. FIG. 7B is a view showing an example of the displayed application basic screen. The screen shown in FIG. 7B is different from FIG. 7A that the information of the communication apparatus 151 is not displayed.

Referring back to step S303, if it is determined in step S303 that the connected AP is included, the process advances to step S304.

In step S304, the CPU 103 displays a message indicating that connection to the connected AP is to be performed. FIG. 6A is a view showing an example of the message screen displayed in step S304. That is, at this time, the screen is a screen, for prompting the user to confirm connection, on which a message 601 including information of the connected AP is displayed.

In step S305, the CPU 103 determines whether an instruction to perform connection to the connected AP is accepted. For example, if a YES button 602 is pressed on the screen shown in FIG. 6A, it is determined that an instruction to perform connection to the connected AP is accepted. In this case, the process advances to step S308 described above, and the CPU 103 displays a screen for accepting input of a password for connection to the connected AP. On the other hand, if a NO button 603 is pressed on the screen shown in FIG. 6A, it is determined that an instruction to perform connection to the connected AP is not accepted. In this case, the process advances to step S306 described above, and the CPU 103 displays the list acquired in step S302.

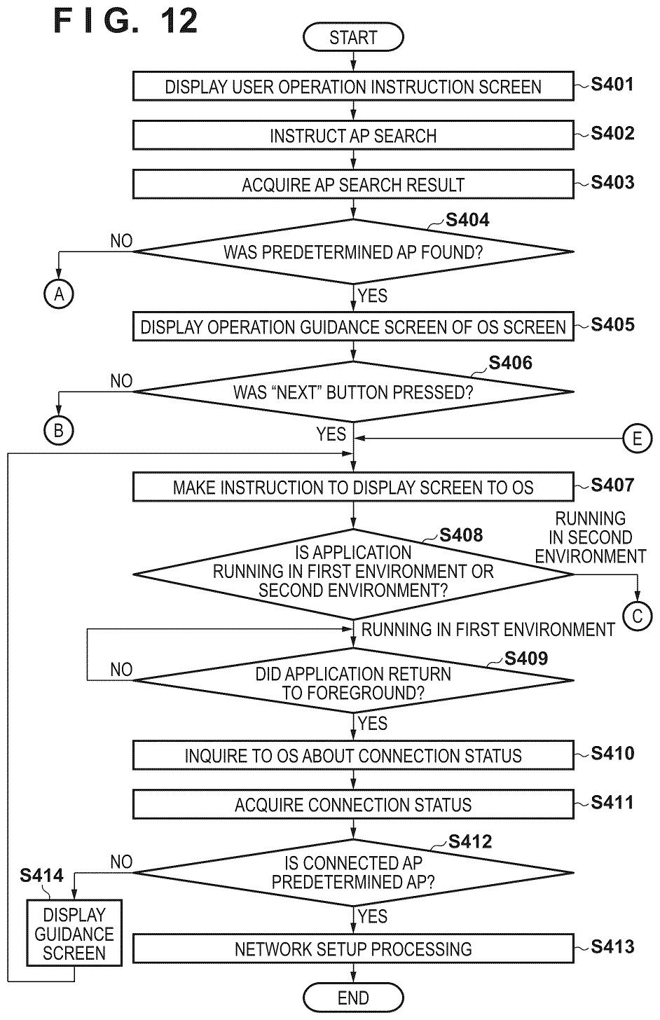

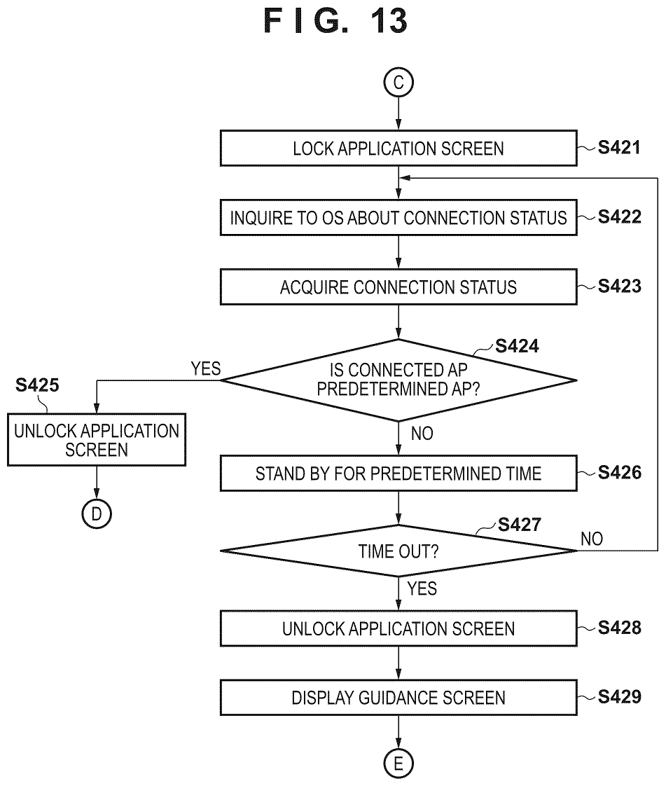

The flowchart of the setup application for implementing the processing shown in FIGS. 9 to 11 will be described below with reference to FIGS. 12 and 13. Processing shown in FIGS. 12 and 13 is implemented when, for example, the CPU 103 reads out programs stored in the ROM 104 into the RAM 105 and executes them.

In step S401, the CPU 103 displays the user operation instruction screen on the operation display unit 108. The processing in step S401 corresponds to that in S101 of FIGS. 9 and S201 of FIG. 10. In step S402, the CPU 103 instructs the OS to execute a search for an external access point (external AP). The OS is the host OS in a case where the information processing apparatus 101 operates in the first environment, and is the guest OS in a case where the information processing apparatus 101 operates in the second environment. The processing in step S402 corresponds to that in S102 of FIGS. 9 and S202 of FIG. 10.

In step S403, the CPU 103 acquires information (search result) of the found external AP, which has been notified from the OS. The processing in step S403 corresponds to that in S104 of FIGS. 9 and S204 of FIG. 10. The OS is the host OS in a case where the information processing apparatus 101 operates in the first environment, and is the guest OS in a case where the information processing apparatus 101 operates in the second environment.

In step S404, based on the search result notified from the OS, the CPU 103 determines whether a predetermined AP has been found. More specifically, for example, it is determined whether the search result notified from the OS includes the character string of the setup access point. The processing in S404 corresponds to that in S105 of FIGS. 9 and S205 of FIG. 10. The OS is the host OS in a case where the information processing apparatus 101 operates in the first environment, and is the guest OS in a case where the information processing apparatus 101 operates in the second environment. If it is determined that the predetermined AP has not been found, the process advances to step S313 of FIG. 11. FIG. 7B is a view showing an example of the application basic screen displayed in step S313 when it is determined that the predetermined AP has not been found. As shown in FIG. 7B, on the application basic screen, buttons such as “print” and “scan”, each of which can accept an instruction of a function executable by the communication apparatus 151, are displayed. On the other hand, if it is determined that the predetermined AP has been found, the process advances to step S405.

In step S405, the CPU 103 displays, on the operation display unit 108, the operation guidance screen for displaying the guidance of the operation to be performed by the user on the OS screen to be displayed next. The processing in step S405 corresponds to that in S106 of FIGS. 9 and S206 of FIG. 10.

In step S406, the CPU 103 determines whether the “next” button is pressed on the operation guidance screen. More specifically, for example, it is determined whether the button 404 of FIG. 4C or the button 504 of FIG. 5B is pressed. If it is determined that the “next” button is not pressed, for example, if a time out has occurred, the process advances to step S313 of FIG. 11. In this case, the application basic screen shown in FIG. 7B is displayed. On the other hand, if it is determined that the “next” button is pressed, the process advances to step S407.

In step S407, the CPU 103 instructs the OS to display the OS screen. The processing in step S407 corresponds to that in S108 of FIGS. 9 and S208 of FIG. 10. The OS is the host OS in a case where the information processing apparatus 101 operates in the first environment, and is the guest OS in a case where the information processing apparatus 101 operates in the second environment. If the information processing apparatus 101 operates in the first environment, the OS screen is displayed on the foreground, and the application screen is displayed on the background. Alternatively, if the information processing apparatus 101 operates in the second environment, the OS screen is displayed, in parallel with the window of the application screen, in the window different from the window of the application screen. In this case, the application screen remains displayed on the foreground.

In step S408, the CPU 103 determines whether the setup application operates in the first environment or the second environment. The processing in step S408 corresponds to that in S114 of FIGS. 9 and S209 of FIG. 10. For example, the CPU 103 may acquire, from the OS, information of whether the environment is a virtual environment, and determine, based on the information, whether the setup application operates in the first environment or the second environment. If it is determined that the setup application operates in the first environment, the process advances to step S409. If it is determined that the setup application operates in the second environment, the process advances to step S421.

In step S409, the CPU 103 determines whether the application screen has returned to the foreground. More specifically, for example, it is determined whether a notification that the application screen has returned to the foreground is received from the host OS. The processing in step S409 is repeated until it is determined that the application screen has returned to the foreground. If it is determined that the application screen has returned to the foreground, the process advances to step S410.

In step S410, the CPU 103 inquires of the host OS about the connection status of the information processing apparatus 101 to the external AP. The processing in step S410 corresponds to that in S117 of FIG. 9. In step S411, the CPU 103 acquires, from the host OS, the connection status to the external AP. The processing in step S411 corresponds to that in S118 of FIG. 9.

In step S412, the CPU 103 determines whether the connected AP is the predetermined AP. More specifically, for example, it is determined whether the connected AP is the setup access point. The processing in step S412 corresponds to that in S119 of FIG. 9. If it is not determined that the connected AP is the predetermined AP, the process advances to step S414. A case where the process advances to step S414 is, for example, a case where the cancel button 407 is pressed on the OS screen shown in FIG. 4D, a case where a time out has occurred, or a case where connection to the external AP has failed (power supply disconnection of the external AP, a Wi-Fi connection error, or the like). In other words, the processing in step S412 is processing for confirming whether connection between the predetermined access point and the information processing apparatus 101 is established.

In step S414, the CPU 103 displays, on the operation display unit 108, a message screen for prompting to perform connection on a Wi-Fi setting screen of OS standard. FIG. 5A is a view showing an example of the message screen displayed in step S414. On a message screen 501, a button 502 for displaying the Wi-Fi setting screen of OS standard is displayed. When the button 502 is pressed, the Wi-Fi setting screen (not shown) of OS standard is displayed, the process returns to step S407, and the CPU 103 instructs the host OS to display the OS screen. At this time, the application screen may be displayed on the background and the screen display may end. The processing shown in FIG. 12 may end and another processing may be executed. If it is determined in step S412 that the connected AP is the predetermined AP, in this example, the setup access point, the process advances to step S413 and the processing shown in FIG. 11 is executed.

If it is determined in step S408 that the setup application operates in the second environment, the CPU 103 performs, in step S421, display control of the currently displayed application screen not to accept a user operation. The processing in step S421 corresponds to that in S212 of FIG. 10.

In step S422, the CPU 103 inquires of the guest OS about the connection status of the information processing apparatus 101 to the external AP. The processing in step S422 corresponds to that in S213 of FIG. 10. In step S423, the CPU 103 acquires, from the guest OS, the connection status to the external AP. The processing in step S423 corresponds to that in S214 of FIG. 10. In other words, the processing in step S422 is processing for confirming whether connection between the predetermined access point and the information processing apparatus 101 is established.

In step S424, the CPU 103 determines whether the connected AP is the predetermined AP. More specifically, for example, it is determined whether the connected AP is the setup access point. The processing in step S424 corresponds to that in S215 of FIG. 10. If it is determined that the connected AP is the predetermined AP, the process advances to step S425. In other words, the processing in step S424 is processing for confirming whether connection between the predetermined access point and the information processing apparatus 101 is established.

In step S425, the CPU 103 cancels the display control in step S421. More specifically, for example, the display of the application screen shown in each of FIGS. 8A to 8C ends. After that, the process advances to step S301 of FIG. 11, and the processing shown in FIG. 11 is executed. The screen of the network setup processing displayed at this time is a screen that can accept a user operation. If it is determined in step S424 that the connected AP is not the predetermined AP, the process advances to step S426.

In step S426, the CPU 103 stands by for a predetermined time by a timer. More specifically, for example, the CPU 103 stands by for 100 ms. Then, in step S427, the CPU 103 determines whether a time out has occurred. More specifically, for example, the CPU 103 determines whether 30 sec has elapsed since execution of the processing in step S422 for the first time. If it is determined in step S427 that a time out has not occurred, the processing is repeated from step S422. That is, in this embodiment, unlike the processing in the first environment, in the processing in the second environment, the processing of inquiring of the OS about the connection status of the information processing apparatus 101 to the external AP is executed based on an elapsed time without receiving, from the OS, the notification that the application screen has returned to the foreground. On the other hand, if it is determined that a time out has occurred, the CPU 103 cancels, in step S428, the display control in step S421. More specifically, for example, the display of the application screen shown in each of FIGS. 8A to 8C ends. In step S429, the CPU 103 displays, on the operation display unit 108, a message screen for prompting to perform connection on the Wi-Fi setting screen of OS standard. FIG. 5C is a view showing an example of the message screen displayed in step S429. On a message screen 510, a button 511 for displaying the Wi-Fi setting screen of OS standard is displayed. When the button 511 is pressed, the Wi-Fi setting screen (not shown) of OS standard is displayed, the process returns to step S407, and the CPU 103 instructs the host OS to display the OS screen. At this time, the application screen may end. Alternatively, the processing shown in FIG. 12 may end and another processing may be executed.

As described above, according to this embodiment, if the information processing apparatus 101 operates in the second environment, the setup application displays the operation guidance on the OS screen, and then performs display control of the application screen so as not to be able to accept a user operation. This can prevent a situation in which an unexpected user operation is accepted and it is thus impossible to start the network setup processing. After performing the above display control, the setup application inquires, at a predetermined time interval, of the guest OS about the external AP to which the information processing apparatus 101 is connected. Thus, even in a configuration in which the notification that the application screen has returned to the foreground is not received from the guest OS, it is possible to start the subsequent network setup processing.

### Second Embodiment

The second embodiment will be described below concerning points different from the first embodiment. In the first embodiment, a form in which when the information processing apparatus 101 operates in the second environment, the application screen and the OS screen are multiwindow-displayed, and thus display control of the application screen in S212 and S213 to S215 for the guest OS are repeatedly performed has been explained. However, as long as the application screen and the OS screen are multiwindow-displayed, the problem described in the first embodiment may arise similarly. For example, even if an information processing apparatus 101 operates in the first environment, if the housing of the information processing apparatus 101 is foldable and includes a plurality of display screens, the same problem may arise. The information processing apparatus 101 is, for example, a portable terminal in which an operation display unit 108 is formed by two displays to be foldable.

In a case where the two displays are set as displays 1 and 2 and the operation of the first embodiment is applied, for example, when the “next” button is pressed in a state in which the operation guidance screen of the OS is displayed on the display 1, the OS screen is displayed in a window different from the window of the application screen on the display 2. That is, even if the information processing apparatus 101 including the plurality of displays has the first environment, it can display a plurality of windows in parallel. That is, in a case where the application screen stands by for a result of processing by the OS, the application screen can accept an unexpected user operation. Since the application screen remains displayed on the foreground, the notification in S116 is not received from the host OS and it is thus possible to start the subsequent network setup processing.

Therefore, in this embodiment, even if the information processing apparatus 101 operates in the first environment, if the information processing apparatus 101 has a predetermined configuration including a plurality of displays like the above-described display, the processing shown in FIG. 10 is executed. This can prevent an unexpected user operation from being accepted on the application screen, thereby making it possible to start network setup processing.

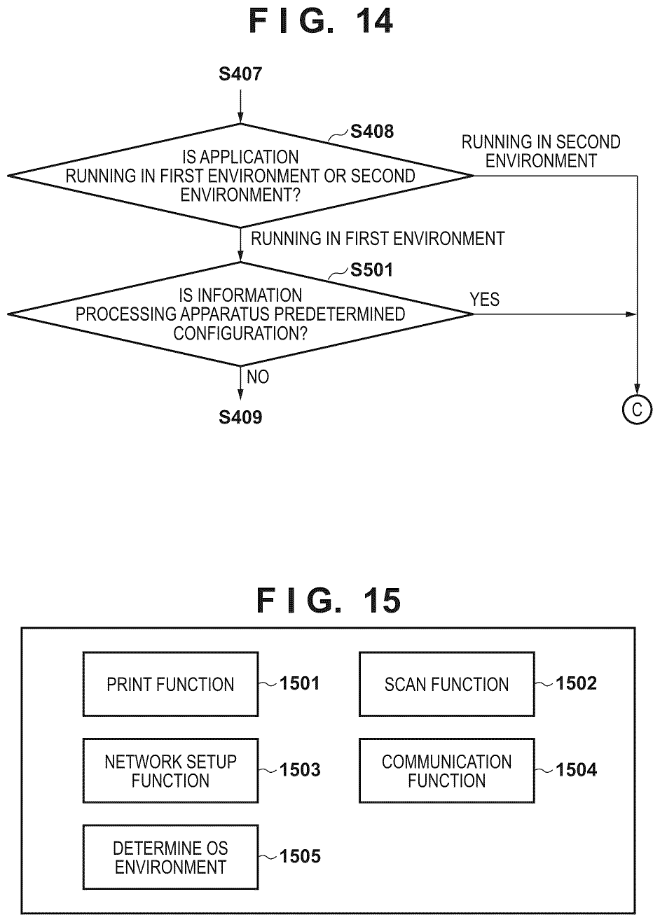

FIG. 14 is a flowchart illustrating a part of the processing of a setup application according to this embodiment. The processing shown in FIG. 14 is implemented when, for example, a CPU 103 reads out programs stored in a ROM 104 into a RAM 105 and executes them.

In this embodiment, processing in step S501 is executed between steps S407 and S409 of FIG. 12. That is, if it is determined in step S408 that the setup application operates in the first environment, the CPU 103 determines in step S501 whether the information processing apparatus 101 has the predetermined configuration. In this example, the predetermined configuration is, for example, a configuration in which the housing of the information processing apparatus 101 is foldable and includes a plurality of display screens. The CPU 103 may acquire device configuration information from the host OS using an API, and determine, based on the information, whether the information processing apparatus 101 has the predetermined configuration. If it is determined that the information processing apparatus 101 does not have the predetermined configuration, the process advances to step S409 of FIG. 12. On the other hand, if it is determined that the information processing apparatus 101 has the predetermined configuration, the process advances to step S421 of FIG. 13.

As described above, according to this embodiment, if the housing of the information processing apparatus 101 is foldable and includes a plurality of display screens, the same processing as that in the case of the second environment described in the first embodiment is executed. This can prevent a situation in which an unexpected user operation is accepted and it is thus impossible to start the network setup processing.

Each of the above-described embodiments has explained the example of displaying the OS screen for connecting the communication apparatus 151 to the external AP. However, the screen that can be displayed by a window different from that of the application screen is not limited to the OS screen. That is, as long as the application temporarily transfers the process to another software, and then executes subsequent processing when the software returns the process, the operation of each of the embodiments is applicable. Then, each of the above-described embodiments has explained the form in which at a timing when the OS screen for connecting the communication apparatus 151 to the external AP is displayed by a window different from that displaying the application screen, control is executed not to perform a user operation on the application screen. However, the timing when the processing of executing control not to perform a user operation on the application screen is executed is not limited to the above-described form.

For example, assume that the application can display an application screen 809 shown in FIG. 8D. Assume also that it is possible to accept the pressing of a button of a cloud photo service on the application screen 809 and display a Web browser screen concerning the cloud phot service. The Web browser screen is, for example, a screen for accepting an operation of selecting one of a plurality of cloud photo services, an operation of logging in to the selected cloud photo service, and an operation of selecting a print target image from a plurality of images managed by the cloud photo service after login. In this configuration, if the operating environment of the application is the first environment, when the pressing of the button of the cloud photo service on the application screen is accepted, the Web browser is activated to display the Web browser screen in a window different from that of the application screen 809. However, since only one window is displayed at one time in the first environment, the Web browser screen is displayed on the foreground and the application screen is displayed on the background. Then, if the Web browser screen is closed upon completion of the above operation on the Web browser screen, the application screen returns to the foreground, and the application executes subsequent processing based on the notification of the return. More specifically, the subsequent processing is, for example, processing for printing the print target image selected on the Web browser screen, and processing of preview-displaying the image and transmitting, to the communication apparatus 151, a print job for printing the image. However, if the operating environment of the application is the second environment, when the pressing of the button of the cloud photo service on the application screen 809 is accepted, a Web browser screen 810 is displayed in a window different from that of the application screen, and the window displaying the application screen and the window displaying the Web browser screen 810 are displayed in parallel, thereby similarly causing the problem described in the first embodiment. For example, in a state in which the pressing of the button of the cloud photo service is accepted on the application screen 809 and the Web browser screen 810 is multiwindow-displayed, the pressing of a button of a cloud storage service can be accepted on the application screen. If the pressing of the button of the cloud storage service is accepted in such state, the standby state for authentication of the cloud photo service of the application is unwantedly canceled, thereby making it impossible to execute the subsequent processing. Furthermore, since a notification that the application screen has returned to the foreground is not sent, it is impossible to start the subsequent processing. Therefore, in a state in which the Web browser screen 810 is displayed in the second environment, the processing of executing control not to perform a user operation on the application screen, which has been described in S212, may be executed. By applying such operation, it is possible to prevent an unexpected user operation from being accepted on the application screen even in a configuration in which the window displaying the application screen 809 and the window displaying the Web browser screen 810 are displayed in parallel. Even if a notification that the application screen has returned to the foreground is not sent, it is possible to start the subsequent processing. Note that the state in which the processing of executing control not to perform a user operation on the application screen, which has been described in S212, is executed need not be a state in which the Web browser screen 810 is displayed in the second environment. That is, the state in which this processing is executed need only be a state in which a screen is displayed by a program different from the setup application in the second environment, and may be a state in which a screen other than the Web browser screen 810 is displayed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-175551, filed Oct. 10, 2023, which is hereby incorporated by reference herein in its entirety.

What is claimed is:

1. A non-transitory computer-readable storage medium that stores a program operatable on an operating system (OS), which when executed by one or more processors of a first information processing apparatus having a first operating environment on a first OS operating as a host OS but not on a guest OS, causes the first information processing apparatus to perform a first method, the first method comprising:
instructing, based on execution of a predetermined operation on a predetermined screen displayed by the program, the host OS to execute first processing for establishing connection between a predetermined access point and the first information processing apparatus, and
executing, after the connection between the predetermined access point and the first information processing apparatus is established by instructing the host OS to execute the first processing, communication via the connection between the predetermined access point and the first information processing apparatus;
wherein the program, which when executed by one or more processors of a second information processing apparatus having a second operating environment on a second OS operating as the host OS and on the guest OS, causes the second information processing apparatus to perform a second method, the second method comprising:
instructing, based on execution of the predetermined operation on the predetermined screen displayed by the program, the guest OS to execute second processing for establishing connection between the predetermined access point and the second information processing apparatus,
executing predetermined control not to execute processing based on an operation on the predetermined screen after instructing the guest OS to execute the second processing, and
executing, after the connection between the predetermined access point and the second information processing apparatus is established by instructing the guest OS to execute the second processing, communication via the connection between the predetermined access point and the second information processing apparatus.

2. The medium according to claim 1, wherein the predetermined control is at least one of processing of preventing the predetermined operation from being accepted, processing of graying out a display button for accepting the predetermined operation, and processing of graying out the entire predetermined screen.

3. The medium according to claim 1, wherein the second method further comprises displaying a screen for presenting an operation to be executed on a screen displayed in a different window by the guest OS while the predetermined control is executed.

4. The medium according to claim 1, wherein in the executing the predetermined control, the predetermined control is started based on the instruction to the guest OS to execute the second processing.

5. The medium according to claim 4, wherein in the executing the predetermined control, the predetermined control is executed until it is confirmed that the connection between the predetermined access point and the second information processing apparatus is established or until a time out of processing of confirming whether the connection between the predetermined access point and the second information processing apparatus is established occurs.

6. The medium according to claim 1, wherein in the executing the communication via the connection between the predetermined access point and the first information processing apparatus, after confirming that the connection between the predetermined access point and the first information processing apparatus is established, information concerning an external access point is transmitted via the connection.

7. The medium according to claim 6, wherein the external access point is an access point to which the first information processing apparatus has been connected before the connection between the predetermined access point and the first information processing apparatus is established.

8. The medium according to claim 6, wherein the external access point is an access point selected from an access point list received from an apparatus operating as the predetermined access point via the connection between the predetermined access point and the first information processing apparatus.

9. The medium according to claim 1, wherein in the executing the communication via the connection between the predetermined access point and the second information processing apparatus, after confirming that the connection between the predetermined access point and the second information processing apparatus is established, information concerning an external access point is transmitted via the connection.

10. The medium according to claim 9, wherein the external access point is an access point to which the second information processing apparatus has been connected before the connection between the predetermined access point and the second information processing apparatus is established.

11. The medium according to claim 9, wherein the external access point is an access point selected from an access point list received from an apparatus operating as the predetermined access point via the connection between the predetermined access point and the second information processing apparatus.

12. The medium according to claim 1, wherein
the first method and the second method further comprises determining whether an environment in which the program is operating is the first operating environment or the second operating environment, and
whether to execute the predetermined control is controlled based on a determination result in the determining.

13. The medium according to claim 12, wherein in a case where it is determined that the environment in which the program is operating is the second operating environment, control is performed to execute the predetermined control.

14. The medium according to claim 13, wherein
the first method further comprises determining, in a case where it is determined that the environment in which the program is operating is the first operating environment, whether the first information processing apparatus is an information processing apparatus having a predetermined configuration as a foldable portable terminal including a plurality of displays,
in a case where it is determined that the first information processing apparatus is the information processing apparatus having the predetermined configuration, control is performed to execute the predetermined control, and
in a case where it is determined that the first information processing apparatus is not the information processing apparatus having the predetermined configuration, control is performed not to execute the predetermined control.

15. The medium according to claim 1, wherein the host OS in the first operating environment is an Android OS, the host OS in the second operating environment is a Chrome OS, and the guest OS in the second operating environment is a virtual Android OS.

16. The medium according to claim 1, wherein the predetermined access point is an access point that is enabled by a printer outside the first information processing apparatus and the second information processing apparatus.

17. The medium according to claim 1, wherein the program is an application program.

18. The medium according to claim 1, wherein the first method and the second method further comprises transmitting, to a communication apparatus, at least one a print job for causing the communication apparatus to execute printing and a scan job for causing the communication apparatus to execute scanning.

19. The medium according to claim 18, wherein the communication apparatus is an apparatus that enables the predetermined access point.

20. A method of controlling a first information processing apparatus having a predetermined program operatable on an operating system (OS) and having a first operating environment on a first OS operating as a host OS but not on a guest OS, and a second information processing apparatus having the predetermined program and having a second operating environment on a second OS operating as the host OS and on the guest OS, the method comprising:
instructing, by the predetermined program in the first information processing apparatus, based on execution of a predetermined operation on a predetermined screen displayed by the predetermined program, the host OS to execute first processing for establishing connection between a predetermined access point and the first information processing apparatus;
executing, by the predetermined program in the first information processing apparatus, after the connection between the predetermined access point and the first information processing apparatus is established by instructing the host OS to execute the first processing, communication via the connection between the predetermined access point and the first information processing apparatus;
instructing, by the predetermined program in the second information processing apparatus, based on execution of the predetermined operation on the predetermined screen displayed by the predetermined program, the guest OS to execute second processing for establishing connection between the predetermined access point and the second information processing apparatus;
executing, by the predetermined program in the second information processing apparatus, predetermined control not to execute processing based on an operation on the predetermined screen after instructing the guest OS to execute the second processing; and
executing, by the predetermined program in the second information processing apparatus, after the connection between the predetermined access point and the second information processing apparatus is established by instructing the guest OS to execute the second processing, communication via the connection between the predetermined access point and the second information processing apparatus.
